(19) United States
(12) Patent Application Publication
(10) Pub. No.: US 2015/0058089 A1
(43) Pub. Date: Feb. 26, 2015

(54) Terrace-Based Computer System for Sale and Purchase of Items and Products

(71) Applicant: Vogel Tether, LLC, Dallas, TX (US)

(72) Inventors: Russell Wells Tether, Carrollton, TX (US); Kevin Eliot Vogel, Dallas, TX (US)

(73) Assignee: Vogel Tether, LLC, Dallas, TX (US)

(21) Appl. No.: 13/971,361

(22) Filed: Aug. 20, 2013

(51) Int. Cl. G06Q 30/02

(52) U.S. Cl. CPC G06Q 30/0206
USPC 705/7.35

(57) ABSTRACT

The invention provides an apparatus and system and computer management for regulating an on-line sale through a communication network. With the present invention, the seller is able to present their product at an optimum price and gradually decrease that price at the pre-arranged published “price drop” levels until the product sells or is removed from the on-line sale. These “price drop” levels can be set as uniform decreases or can be set individually by the seller. Purchasers can also place advanced future “reserve” commitments to purchase at pricing below the current asking price for a particular item.

### RELATED APPLICATION DATA

None.

### TECHNICAL FIELD OF THE INVENTION

The present invention relates to computer management system that controls and regulates the sale of authorized items.

### BACKGROUND OF THE INVENTION

The present invention is based in part on the Internet technology of webpages, websites, and website addresses, as well as an integrated computer management software system. Present-day Internet communications represent the synthesis of technical developments begun in the 1960s—the development of a system that supports communication between different United States military computer networks, and the subsequent development of a system to support the communication between research computer networks at United States universities. These technological developments would subsequently revolutionize the world of computing.

### The Internet

The Internet, like so many other high tech developments, grew from research originally performed by the United States Department of Defense. In the 1960s, Defense Department officials began to notice that the military was accumulating a large collection of computers—some of which were connected to large open computer networks and others that were connected to smaller closed computer networks. A network is a collection of computers or computer-like devices communicating across a common transmission medium. Computers on the Defense Department's open computer networks, however, could not communicate with the other military computers on the closed systems.

Defense Department officials requested that a system be built to permit communication between these different computer networks. The Defense Department recognized, however, that a single centralized system would be vulnerable to missile attacks or sabotage. Accordingly, the Defense Department mandated that the system to be used for communication between these military computer networks be decentralized and that no critical services be concentrated in a few, vulnerable failure points. In order to achieve these goals, the Defense Department established a decentralized standard protocol for communication between network computers.

A few years later, the National Science Foundation wanted to connect network computers at various research institutions across the country. The NSF adopted the Defense Department's protocol for communication, and this combination of research computer networks would eventually evolve into the Internet.

The Defense Department's communication protocol governing data transmission between computers on different networks was called the Internet Protocol (IP) standard. The IP standard now supports communications between computers and networks on the Internet. The IP standard identifies the types of services to be provided to users, and specifies the mechanisms needed to support these services. The IP standard also describes the upper and lower system interfaces, defines the services to be provided on these interfaces, and outlines the execution environment for services needed in the system.

A transmission protocol, called the Transmission Control Protocol (TCP), was also developed to provide connection-oriented, end-to-end data transmission between packet-switched computer networks. The combination of TCP with IP (TCP/IP) forms a system or suite of protocols for data transfer and communication between computers on the Internet. The TCP/IP standard has become mandatory for use in all packet switching networks that connect or have the potential for utilizing connectivity across network or sub-network boundaries.

In a typical communications scenario, data is transmitted from an applications program in a first computer, through the first computer's network hardware, and across the transmission medium to the intended destination on the Internet. After receipt at a destination computer network, the data is transmitted through the destination network to a second computer. The second computer then interprets the communication using the identical protocols on a similar application program. Because of the standard protocols used in Internet communications, the TCP/IP protocol on the second computer should decode the transmitted information into the original data transmitted by the first computer.

A computer operating on a network is assigned a unique physical address. On a Local Area Network (“LAN”), the physical address of the computer is a number given to computer's network adapter card. Hardware LAN protocols use this physical address to deliver packets of data to computers on the LAN.

On the Internet, the TCP/IP protocol routes data packets using logical addressing. Logical addresses are generated by the network software in the Network Layer. Specifically, a logical address in the TCP/IP network is translated into a corresponding physical address using the ARP (Address Resolution Protocol) and RARP (Reverse Address Resolution Protocol) protocols in the Network Layer.

The TCP/IP's logical address is also called an IP address. The IP address can include: (1) a network ID number identifying a network, (2) a sub-network ID number identifying a sub-network on the network, and, (3) a host ID number identifying a particular computer on the sub-network. The IP addressing scheme imposes a sensible addressing scheme that reflects the internal organization of the network or sub-network.

A computer network is often subdivided into smaller sub-networks. The computer network is divided in this manner to increase data transmission efficiency and reduce overall network traffic. Routers are used to regulate the flow of data into and out of designated sub-networks of the computer network. A router interprets the logical address information of a data packet, such as an IP address, and directs the data packet across the network to its intended destination. Data addressed between computers on the sub-network does not pass through the router to the greater network, and therefore does not clutter the transmission lines of the greater network. If data is addressed to a computer outside the sub-network, however, the router forwards the data onto the larger network.

### Auctions

Auctions are a known option for marketing, generating interest, and selling real and personal property. In the past, auctions have used different techniques to match a bidder with a product or service being sold. Auctions have traditionally included a series of increasing bid auctions from a base initiation price where the bid price for a property item increases over time with each successive bid. Auctions have also been conducted where an elevated initial asking price is set, and over time, this price decreases over time until someone accepts the price for the property item. Dutch auctions are known where bidders with winning bids are allowed to pay the price paid by the winning bidder with lowest bid.

Prior art online bid auctions have been used in the past, where for example, a boat is auctioned and bidders (buyers) visiting the auction site bid upward from a smaller amount of money to the final bid price or view the asking price set and wait to see if the set asking price is lowered to the point where it is accepted by the bidder/buyer. Online systems for auctioning products and services are known in the art, such as the auction website maintained by eBay Corporation at its website (URL: http://www.ebay.com). Another example is provided by Ezhilchelvan and Morgan in their paper, which describes a distributed system for Internet-based on-line auctions. Paul Ezhilchelvan and Graham Morgan, “A Dependable Distributed Auction System: Architecture and an Implementation Framework”, Proceedings of the 5th International Symposium on Autonomous Decentralized Systems (ISADS 2001), IEEE Computer Society Press 2001 (URL:http://www.cs.ncl.ac.uk/research/pubs/inproceedings/papers/218.pdf)).

Several patent publications show a descending bid auction, which include United States Patent Publ. No. 2009/0248563 entitled “Method and Apparatus for On-Line Auctions” to Michael Deasy, et al, United States Patent Publ. No. 2006/0200401 entitled “Online Descending Bid Auction” to Gil Lisani, et al, United States Patent Publ. No. 2001/0027433 entitled “Auction System, Method and Apparatus” to Yasuhisa Fujiwara, et al., and U.S. Pat. No. 7,941,344 entitled “Method and Apparatus for Time Incremented Purchase Price Discounting” to Bickerstaff.

### Selling Estate and Collection Assets

A family, or an estate, wanting to sell a collection of artist works would usually conduct a house sale, an estate sale, dealer sale, or a traditional or online auction.

In a Studio Sale with (for example) hundreds objects to sell, a studio sale will sell a number of the works to the friends of the artist and neighbors, but at prices that would be considered “low” or below market value. The family will probably retain 90% or more of the collection as unsold items after a Studio Sale. That is, the best works of art in the collection will be sold without selling a vast majority of the collection. Once the Studio Sale is conducted, attentive ways of selling the collection may no longer be viable.

In an Estate Sale, an estate sale professional will have a local list of several hundred prospective buyers in addition to the friends and family of the artist. The probability is that an Estate Sale may do a little better than a Studio Sale, but many of the same pitfalls would be encountered. Namely, prices achieved would be considered “low” or below market value, 90% or more of the collection items will remain unsold after the Estate Sale, the best works of art in the collection will be sold without selling a vast majority of the collection items, and once the Estate Sale is concluded, the other ways of selling the collection may no longer be viable.

The works in the collection would have to be of a very high quality in the opinion of a dealer for them to get involved in a Dealer Sale. The dealer might be able to sell a number of the best works in a show at appropriate prices. But, the same deficiencies in the Studio and Estate Sales would be encountered, which are 90% or more of the collection items will remain unsold after the Dealer Sale, the best works of art in the collection will be sold without selling a vast majority of the collection items, and once the Dealer Sale is concluded, the other ways of selling the collection may no longer be viable.

Dealers may publish a catalogue, with the financial assistance of the estate, to help increase sales. Art fairs may be attended by the Dealer, and they may even be able to arrange a museum show for the artist's collection. A significant problem with the Dealer Sales, however, is the lack of transparency in their business dealings.

In a traditional Auction House sale, the work has to be important enough for a traditional auction house to get involved with its sale. An auction house will not sell an entire collection unless the collection items are all in one lot or divided up into a small number of lots. Selling all the works in a collection at once will likely destroy any market value that was created for the artist's works, which is counterproductive to the goals of most auction houses. If the auction house becomes involved with the sale of works in a collection, the auction house will pick only the best works from the estate collection for its auction, and the auction house will likely promote the work online for a month or so and have several days of previews for locals to come by and see all the works selected for that specific auction.

In a regular “live” auction, the average time a single work is “up” to be “bid on” averages about 60 seconds. Almost all of these regular “live” auctions are conducted online in addition having live participants in attendance, but inconsistencies in Internet connectivity make bidding difficult for those who are not personally in attendance. A significant drawback for a traditional auction is the publication of the sales results, which can establish a low property value for a collection. These auction results are made accessible to people subscribing to an auction results service. Also, most of the problems associated with the other sales modes described above will also be encountered by a traditional or on-line auction, which include 90% or more of the collection items will remain unsold after the auction, the best works of art in the collection will be sold without selling a vast majority of the collection, and once the auction is concluded, the other ways of selling the collection items may no longer be viable.

For Online Sales Platforms, most online auction platforms follow the traditional “highest bid wins” concept. Unlike a traditional auction, online auction platforms have an item posted online for a period of time to attract as many bidders as possible. To keep people engaged, their works are online for a maximum of several weeks so people do not lose interest in the process. These “on-line” auctions do not require a licensed auctioneer so there are no set rules governing how the auction is conducted, how the items are registered, valued, or sold, and what will happen to the asking price of an item in the future. With a “highest bidder” wins auction, people running the auction can be bidding against you to raise the price of a work without your knowledge. E-bay type sites also use the “highest bid wins” approach but anyone is able to put work up and the bidder is at the mercy of those who know nothing about the items they are selling. There is also rampant fraud associated with on-line Ebay auctions.

There is a problem with current auction technology, on-line or otherwise, in that there is no centralized control of the management system of the auction activities, no consistent regulation of items to be offered, and no registration of the property items in a centralized web-site accessible database where registration on the management system is performed by professionals knowledgeable in the field. The on-line and other auction sites are also deficient in their ability to handle collections of art or other property items, and transparency between the buyer and the seller. Independent auction firms to date have been unable to assemble the appropriate platform or alliance to be successful on a larger scale. Of the above systems and methods, none of these known systems solves the problems in the market.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIGS. 1, 2, 3a and 3b are block diagrams showing system components used with the present invention, and,

FIGS. 4 to 12 shows a program sequence flows for the embodiment described in the present invention.

### SUMMARY OF THE INVENTION

The present invention was designed to sell an artists' collection or estate works at the highest possible market value within a reasonably short period of time and with a maximum level of transparency for both the seller and the buyer. By avoiding the traditional “highest bid wins” concept, the present invention enhanced addresses the deficiencies in the prior art by using professionals to register an item for sale with appropriate information to create a published “price drop” schedule for each item being sold using the on-line system. This “price drop” schedule promotes transparency, allows the buyer to track online the discounting schedule of an item, and gives each work enhanced addresses the deficiencies in the prior art by using market visibility to maximize sale prices. The present invention can be used to sell collectable items online at higher market prices. The present system also uses an e-commerce web format to sell unique valuable collector items or large collections of fine art, antiques, watches, automobiles, or any other such items at a maximum market value while providing maximum business transparency to both the seller and buyer.

The present invention has a website that is used by professionals, who are knowledgeable about the market, to register particular items for the sale process. These professionals work with prospective sellers to identify sale items, take custody of the items to be sold, register and catalogue the sale item on the website, and determine the sale parameters that will be used for each item, such as when and at what price the items will go on sale online, when the item will be taken off the online sale, and the increment of time and schedule of price drops during the sale process.

The process generally works as follows: Registered agents for the Seller places item on the management database, and initiates the sole of the items at a certain time for a certain asking price. The product will remain at that asking price for a pre-arranged time. If the product has not sold by the end of the first time frame, the price of that product will be reduced by a pre-arranged percentage or amount. This process of reducing the asking price will continue until the product is sold, or removed from the market. With the present invention, the seller is able to present their product at an optimum price and gradually decrease that price at the pre-arranged pricing levels until the product sells. These predetermined price drop levels can be set as uniform decreases or each Terrace decreased sales pricing level can be individually set by the seller, but the price decrease will be published in a price drop table so purchasers can buy or place a reserve commitment on an item at a certain price level.

The “profile” entered onto the management database for the sale of an item will include setting seven parameters that include: (1) starting sale price, (2) when the item shall be posted for sale, (3) length of time to first price decrement, (4) length of time between successive price decrements, (5) amount of each price decrement, (6) time of day when decrement occurs, (7) when the item will be taken down from being posted for sale.

After an item is entered onto the management system, a starting price will be determined for an item and the time and date it will go on-line for sale will be determined. The length of time the item will remain at the initial price will be set, and, at the end of the initial time period (or before), the price will be decreased. A published “price drop” schedule will show the time and date for price drops that follow. This decremental pricing schedule is created by determining the time between each price drop, the amount of each price drop, and the time of day of each scheduled drop. A final price decrement will be set that establishes a floor below which the asking price of the item will not fall, and the timing for taking the product off the on-line sale website will be established.

With the present on-line system, all items published for sale on the website will be sold on a first commitment basis. No one will be able to purchase an item at a price below the current asking price setting, but a buyer will be able to take a future “reserve” commitment position to buy an item upon a specific price drop date and time. When the reserve commitment is set, the purchaser will be shown to have reserved the item before the price drops to that level and shown to have bought or purchased the item after the price drops to the reserved commitment level if someone does not purchase the item before that decrement in price.

For example, if a person places a reserve commitment to purchase an item on Mar. 6, 2012 at 1:00 pm cst for $6,633.90, that person will click on the reserve tab on that line and then register to purchase the work at that price, which includes the buyer giving all their contact and credit card information. The person making that reserve commitment at that level will also make appropriate guarantees to purchase the item at that pricing level.

In this manner, purchasers can place a future “reserve commitment” significantly below a current asking price for a particular product item. When other potential buyers try to place an offer at the same level, they are told that someone has already placed a reserve commitment at that price level. The person will then have to decide whether to place their own reserve commitment at a higher asking price. The seller is also notified about the reservations and sale of the product.

Compared to known systems, the present invention allows considerably more time for all interested parties to view the product and decide if they want to pursue it and at what price or reservation level. The present invention also allows potential buyers worldwide the opportunity to participate, thus increasing the potential of selling the product at the maximum price.

### DETAILED DESCRIPTION OF THE INVENTION

The invention provides an apparatus and system for holding an on-line sale of a collection of items through the use of a computer management system accessible through a communication network. The computer management system employed in the invention includes equipment having the functions of processing, inputting and outputting data, as well as the function of communicating. There is thus provided, in accordance with a preferred embodiment of the present invention, a system and method for an online sale of an item or items over a network with a plurality of clients, including a server connected to the network for managing the on-line sale. The present invention is a new computerized system that maximizes market values of offered products, and the present system works contrary to methods employed by traditional auctions and bidding processes.

The present invention was designed to sell an artists' collection works at the highest possible market value within a reasonably short period of time and with a maximum level of transparency for both the seller and the buyer. By avoiding the traditional “highest bid wins” concept, the present invention employs a computer management system where items are registered by professionals and information and parameters regarding the sale are used to create a published “price drop” schedule for each item. This “price drop” schedule allows purchasers to predict when “price drops” will occur, allows buyers to track online the discounting schedule of a work, and gives each item maximum market visibility to maximize sale prices. The present invention can be used to sell collectable items online at their highest market price. The present system also uses an e-commerce web format to sell unique valuable collector items or large collections of fine art, antiques, watches, automobiles, or any other such items at a maximum market value while providing maximum business transparency to both the seller and buyer.

The present system used a website where professionals, who are knowledgeable about the market, register particular items for the on-line sale process. These professionals work with prospective sellers to identify sale items, take custody of the items to be sold, register and catalogue the sale item on the website, and determine the sale parameters that will be used for each item, such as when and at what price the items will go on sale online, when the item will be taken off the online sale, and the increment of time and schedule of price drops during the sale process.

The process generally works as follows: Agents of the seller register items for the on-line sale of the item. The item will be placed on sale at an initial asking price, and the item will remain at that asking price for a pre-arranged time. If the product has not sold by the end of the initial time frame, the asking price of that product will be reduced by a pre-arranged percentage or amount. This process of reducing the asking price (and waiting) will continue until the product is sold, or removed from the on-line sale. With the present invention, the seller is able to present their product at an optimum price and gradually decrease that price at the pre-arranged “price drop” levels until the product sells or the sale ends. These “price drop” levels can be set as uniform decreases or each “price drop” level can be individually set by the seller.

The “profile” information for the sale of the item input for the seller on the computer management system will include setting seven parameters that include: (1) starting sale price, (2) when the item shall be posted for sale, (3) length of time to first price decrement, (4) length of time between successive price decrements, (5) amount of each price decrement, (6) time of day when decrement occurs, (7) when the item will be taken down from being posted for sale.

After an item is catalogued, an initial asking price will be determined for an item when it will go on-line for sale. The timing for the on-line sale will also be determined and input onto the computer management system. The length of time the item will remain at the initial price will be set, and at the end of the initial time period, the price drop according to the “price drop” level. A published schedule of “price drops” is published showing the date, time and asking price amount of each price drop level. This “price drop” schedule is created by determining the time between each price drop, the amount of each price drop, and the time of day of each scheduled drop. A final price decrement will be set that establishes a floor below which the sale price of the item will not fall, and the timing for taking the product off the on-line sale website will be established.

Each profile item input onto the computer management system for each sale item is explained below as follows:

1. Starting price: The asking price at which an item or items will first appear online will be input onto the computer management system by the professional who registered the item on the database. This price will be determined based on discussions with the owner of the item, which many be determined by the contractual agreement between them. Because items will drop from this starting price, most items will having a starting price that is above the “expected market value” or end sale price.

2. When to place item online: A time and date must be established as to when an item is to go online, and items (or groups of items) can be scheduled to go online immediately upon registration or at a later time as dictated by what is input onto the computer management system. This “on-line” sale initiation can be done manually or scheduled to start at a predetermined time, but the computer management system will regulate and initiate the initiation of the on-line sale.

3. Length of first price decrement: After an item or items go live online, there will be a length of time before the first price decrease or “price drop.” This length of time should be input into the computer management system by the professional who catalogued the item. In most cases, this first increment will be longer than the timing of the price drops that follow. The initial price drop timing should be long enough to allow as many buyers as possible to find the item, but not long enough that prospective buyers become disinterested. An algorithm will help to determine this time based on page views and other metrics.

4. Time between individual price drops: A schedule of subsequent price drops must be input onto the computer management system, which creates a “price drop” schedule for publication. Although the present system will allow for any timing schedule between incremental price drops, in most instances, the price drops can be dictated by the items being sold. As an example, after the first price increment, it is dictated that the price of the item will drop every 14 days for 4 increments. This will allow more people to discover the item online and the price drops are far enough apart that the buyer may not see a reason to wait for another incremental drop before purchasing. If the artwork is not purchased by the end of the aforementioned two month cycle, the schedule can be speeded up so the prices will drop every 7 days until the item is sold or it has reached its lowest price increment. This will speed up the process on an item that was not important enough for a collector to acquire at an earlier price increment.

5. Amount of each price drop (specific amount or %) The user will input the amount of each incremental price drop for an item into the computer management system. Although the amount of each incremental price drop of an item or items in the system does not need to be the same, it is probably best that they are. The price drops can be specific amounts or a percentage of what the price was at the previous asking price level. Example 1: An item goes live online and it is determined that at each price reduction increment, the price will be reduced by 10% of its current price. Example 2: It is determined that the first 6 incremental price drops, the price of the item will be reduced by $1,000. Then the item will be reduced in increments of 10% until the item is sold or reaches its lowest established increment.

6. Time of day each price drop occurs: The user needs to input the time of day each incremental price drop will occur onto the computer management system. Although each incremental price drop in the system can occur at any time of day or night, it is important they remain consistent for a specific item or group of items that are part of an on-going on-line sale. Example: An item is to be placed online. Because the most likely purchaser lives on the east coast of the U.S.A. and is likely to go to lunch at 12:00 pm est, the item's drop time may be scheduled for 11:00 am cst so the most likely buyers will be free at the moment of drop and they can still make lunch after the purchase.

7. Final pricing: The user will input onto the computer management system an incremental level an item will be taken off it on-line sale status. Items that have reached their lowest timed price increment will be taken off the on-line sale website by the computer management system and those items may be returned to the owner or consignor, placed back on live status at a later date, or placed onto a different sale site.

For the sake of transparency, price drop intervals are published on a price reduction schedule. An example of a published table of price drops is shown below. If not purchased before a particular price drop occurs, the exact moment of each price drop and the expiratory date line will disappear so the current price cycle will move to the top. The example table published on the website shows a 10% price reduction every 14 days.

Published Price Decrement Table: Product Item “A”

| Start Date: | Start Time: | Start Price: |
|---|---|---|
| 1/10/12 | 1:00 pm cst | $10,000 |
| 1/24/2012 | 1:00 pm cst | $9,100.00 Buy |
| 2/7/2012 | 1:00 pm cst | $8,190.00 Reserve |
| 2/21/2012 | 1:00 pm cst | $7,371.00 Reserve |
| 3/6/2012 | 1:00 pm cst | $6,633.90 Reserve |
| 3/20/2012 | 1:00 pm cst | $5,970.51 Reserve |
| 4/3/2012 | 1:00 pm cst | $5,373.46 Reserve |

With the present on-line system, all items published for sale on the website will be sold on a first commitment basis. No one will be able to purchase an item at a price below the current asking price setting. A buyer will be able to make a future “reserve” commitment to buy an item after a specific price drop date and time occurs. When the reserve is set, the purchaser will be shown to have reserved the item at the moment the future price drop level. If someone does not purchase the item before that decrement in price, the person setting the reserve commitment will be shown to have bought or purchased the item.

If a person makes a future reserve commitment at one of the visible “price drop” levels, all of the published decrements below the reserved one can be removed from the “price drop” list or the word “Reserve” can be placed on those lower “price drop” levels. For example, if a person enters a “reserve” commitment on an item listed for a “price drop” at Mar. 6, 2012 at 1:00 pm cst for $6,633.90, that person will click on the reserve tab on that line and then register to purchase the work at that asking price. The buyer has to submit to the computer management system all their contact and credit card information, with a contractually binding commitment to purchase.

When finished and credit limit is confirmed on their credit card, all the times under that date will be removed from the table or listed as reserved. If no one purchases the item before the date and time of the reserved commitment decrement, the item will be purchased by the person who reserved it at that level. After the person has entered a reserve commitment onto the computer management system for the item at a specific price decrement level, another person can purchase the product item before the asking price is reduced to that specific price decrement level or place a reserve price commitment at a price above the highest reserved price decrement level.

In the above example, another person can place a reserve price commitment at Feb. 7, 2012 at 1:00 pm cst for $8,190.00, which is above the highest reserve pricing level for Mar. 6, 2012 of $6633.90. After this second person places a reserve commitment for the Feb. 7, 2012 price decrement, the present invention will inform the person who placed the reserve commitment at Mar. 6, 2012 at 1:00 pm cst for $6,633.90 that someone has committed to purchase the work at Feb. 7, 2012 at 1:00 pm cst for $8,190.00. The system will inquire if that person would like to purchase the work at the current price or place a higher reserve commitment price.

In this manner, purchasers can place advanced future reserve commitments significantly below a current asking price for a particular product item. When a potential buyer tries to place a reserve commitment at the same level, they are told that such an action is conflicted by a prior reserve commitment at that price level. The new buyer then has to decide whether to place a higher reserve commitment than previously entered in to the computer management system. The seller is also notified about reservations and sales of product.

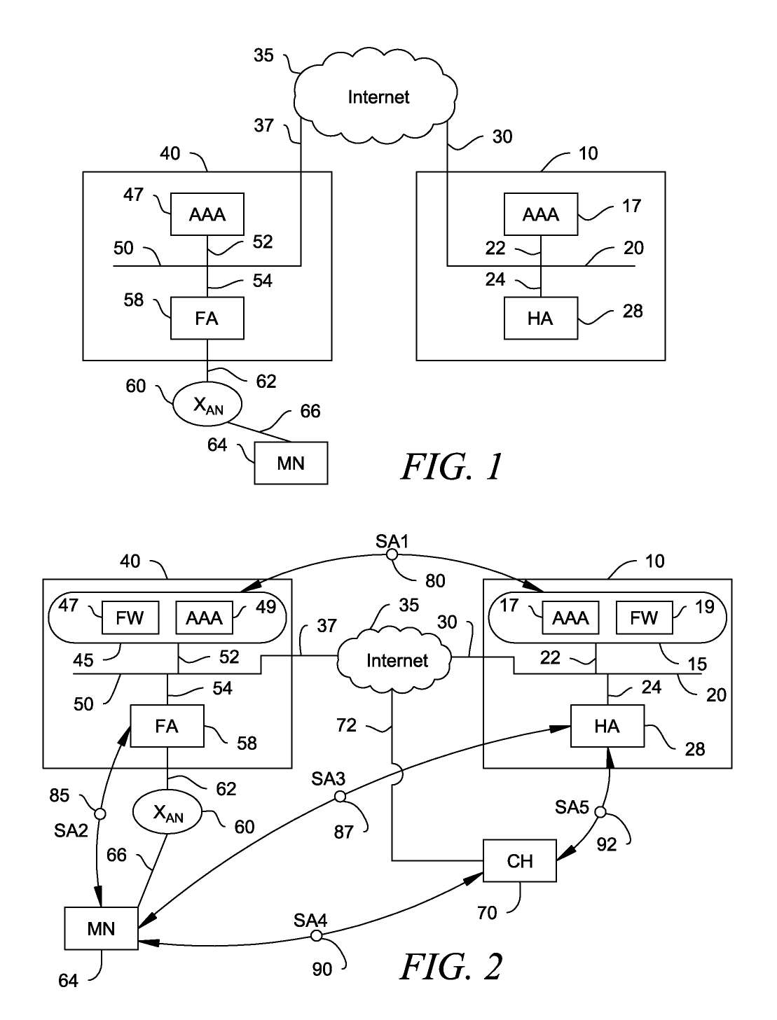

FIGS. 1, 2, 3a and 3b show system components that support the use and implementation of the present invention. In FIG. 1, an on-line access system is shown with the overall architecture of the IP-based mobile system having a Mobile Node 64, a home network 10 and a foreign network 40. The home network 10 has a central buss line 20 coupled to the Home Agent 28 via communication link 24, and the buss line 20 is coupled to the AAA server 17 via communication link 22. The home network 10 is coupled to the public Internet 35 via communication link 30. A communications link is any connection between two or more nodes on a network or users on networks or administrative domains.

The foreign network 40 has a central buss line 50 coupled to the foreign agent 58 via communication link 54, and the buss line 50 is coupled to the AAA foreign network server 47 via communication link 52. The foreign network 40 is coupled to the public Internet 35 via communication link 37.

Mobile Node 64 is shown electronically coupled to the foreign network 40 via the wireless communication link 66 of transceiver 60. Transceiver 60 is coupled to the foreign network 40 via communication link 62. The Mobile Node 64 can communicate with any transceiver or Access Network coupled to the foreign network 40.

The terms Home Agent and Foreign Agent may be defined in the Mobile IP Protocol (RFC 2002), but these agents are not restricted to a single protocol or system. In fact, the term Home Agent, as used in this application, can refer to a Home Mobility Manager, Home Location Register, Home Serving Entity, or any other agent at a home network having the responsibility to manage mobility-related functionality for a Mobile Node on a home network. Likewise, the term Foreign Agent, as used in this application, can refer to a Serving Mobility Manager, Visited Location Register, Visiting Serving Entity, or any other agent on a foreign network having the responsibility to manage mobility-related functionality for a Mobile Node on a foreign network.

In the mobile IP communications system, the Mobile Node 64 may be identified by a permanent IP address. While the Mobile Node 64 is coupled to its home network 10, the Mobile Node 64 functions as any other fixed node on that network. When the Mobile Node 64 moves from its home network 10 to a foreign network 40, however, the home network 10 sends data communications to the Mobile Node 64 by “tunneling” the communications to the foreign network 40 where the Mobile Node 64 is located.

The Mobile Node 64 keeps the Home Agent 28 informed of its current location by registering a care-of address with the Home Agent 28. Essentially, the care-of address represents the current foreign network 40 where the Mobile Node is located. If the Home Agent 28 receives an information packet addressed to the Mobile Node 64 while the Mobile Node 64 is located on a foreign network 40, the Home Agent 28 will “tunnel” the information packet to the Mobile Node's 64 current location on the foreign network 40 via the applicable care-of address.

If the Mobile Node 64 is located on its home network 10, no additional action needs to be taken because information packets will be routed to the Mobile Node 64 according to the standard addressing and routing scheme. If the Mobile Node 64 is visiting a foreign network 40, however, the Mobile Node 64 obtains appropriate information from the agent advertisement, and transmits a registration request message to its Home Agent 28. The registration request message will include a care-of address for the Mobile Node 64.

The registered care-of address identifies the foreign network 40 where the Mobile Node 64 is located, and the Home Agent 28 uses this registered care-of address to tunnel information packets to the foreign network 40 for subsequent transfer to the Mobile Node 64. A registration reply message may be sent to the Mobile Node 64 by the Home Agent 28 to confirm that the registration process has been successfully completed.

A care-of address identifies the foreign network 40 where the Mobile Node 64 is located. Mobile IP protocols require that the mobile node register the care-of address with the Home Agent 28 and/or the AAA server 17 on the home network 10 after movement to a new network. As part of the registration process, a registration request is issued by the Mobile Node 64 in response to power-up on the foreign network 40 or receipt of an agent advertisement. The registration request is sent to the Home Agent 28 and/or the AAA server 17 on the home network, and a registration reply is issued by the Home Agent 28 to the Mobile Node 64 to confirm registration of the care-of address with the Home Agent 28. The registration is transmitted from Mobile Node 64 or the Foreign Agent 58 to the Home Agent 28 via Internet 35. The AAA server 17 also allows the Mobile Node 64 to access the home network 10.

In the system shown in FIG. 1, the Mobile Node 64 would have a care-of address of the foreign network 40, and the Mobile Node 64 would have registered its care-of address with the Home Agent 28. When an information packet is sent to the Mobile Node 64, these information packets would be sent to the Home Agent 28 as the agent advertising accessibility to the Mobile Node 64 on the networks. The access network in FIG. 1 is part of the network architecture that supports the use and implementation of the system described herein.

The Home Agent 28 would transfer, or tunnel, the information packets to the Foreign Agent 58 at the care-of address for the Mobile Node 64. The Foreign Agent 58 would, in turn, transfer the information packets to the Mobile Node 64 through the transceiver 60. In this manner, the information packets addressed to the Mobile Node 64 at its usual address on the home network 10 are re-directed to the Mobile Node 64 on the foreign network 40.

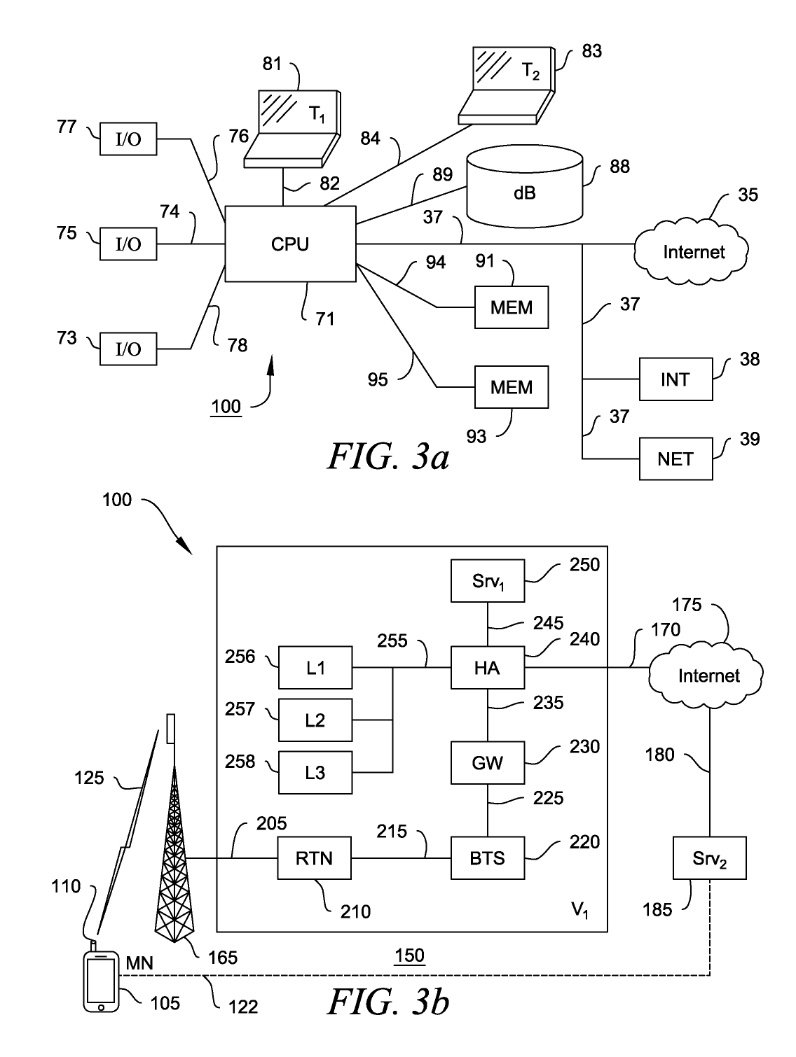

Looking at FIG. 2, the overall architecture of another IP-based mobile system is shown with Mobile Node 64, home network 10 and foreign network 40. The home network 10 has a central buss line 20 coupled to the home agent 28 via communication link 24, and the buss line 20 is coupled to the secure messaging gateway 15 via communication link 22. The secure messaging gateway 15 includes the AAA server 17 and firewall 19 for the home network. The home network 10 is coupled to the public Internet 35 via communication link 30. A communications link is any connection between two or more nodes on a network or users on networks or administrative domains.

The foreign network 40 has a central buss line 50 coupled to the foreign agent 58 via communication link 54, and the buss line 50 is coupled to the secure messaging gateway 45 via communication link 52. The secure messaging gateway 45 includes the AAA server 49 and firewall 47 for the foreign network. The foreign network 40 is coupled to the public Internet 35 via communication link 37.

A Mobile Node 64 is shown electronically coupled to the foreign network 40 via the communication link 66 of transceiver 60. Transceiver 60 is coupled to the foreign network via communication link 62. The Mobile Node 64 can communicate with any transceiver or Access Network coupled to the foreign network 40. The system also includes a correspondent node CN 70, which is a node wishing to communicate with the Mobile Node 64. The correspondent node CN 70 is coupled to the public Internet 35 via communication link 72.

The present invention includes the capability of forming five different SAs securely connecting various nodes and routers on the Internet. The following security associations will connect the following nodes and routers:
(1) SA1—the SA1 80 securely connects the secure messaging gateway 15 in the home network 10 to the secure messaging gateway 45 in the foreign network 40,
(2) SA2—the SA2 85 securely connects the Mobile Node 64 to the Foreign Agent 58 in the foreign network 40,
(3) SA3—the SA3 87 securely connects the Mobile Node 64 to the Home Agent 28 in the home network 10,
(4) SA4—the SA4 90 securely connects the Mobile Node 64 to the correspondent node 70, and
(5) SA5—the SA5 92 securely connects the correspondent node 70 to the Home Agent 28 in the home network.

The security scheme in the present invention covers one or more portions of the public network as mandated by the needs of the user and the level of security desired. At the very least, SA1 80 is needed to traverse the public networks in the Internet. If SA1 80 and SA2 85 (or an equivalent) are available and the foreign network 40 can be trusted, SA3 would be optional because it would cover redundant relationships already covered by SA1 and SA2. Further, SA4 is only needed if the policies at the Mobile Node 64 require its use. If SA1 80 is not available, the system should secure transmission of information packets by using SA3 87 and SA4 90 between the Mobile Node 64 and the Home Agent 28 or correspondent node 70, respectively.

SA2 connection may be unnecessary if the Mobile Node 64 communicates with the Foreign Agent 58 using a code-based communication scheme, such as a CDMA-based communication scheme. Further, the security of the system could be enhanced by SA5 92 between the correspondent node 70 and the Home Agent 28 if the correspondent node 70 is not associated with the home network. The network shown in FIG. 2 is the network access architecture that supports the use and implementation of the system described herein.

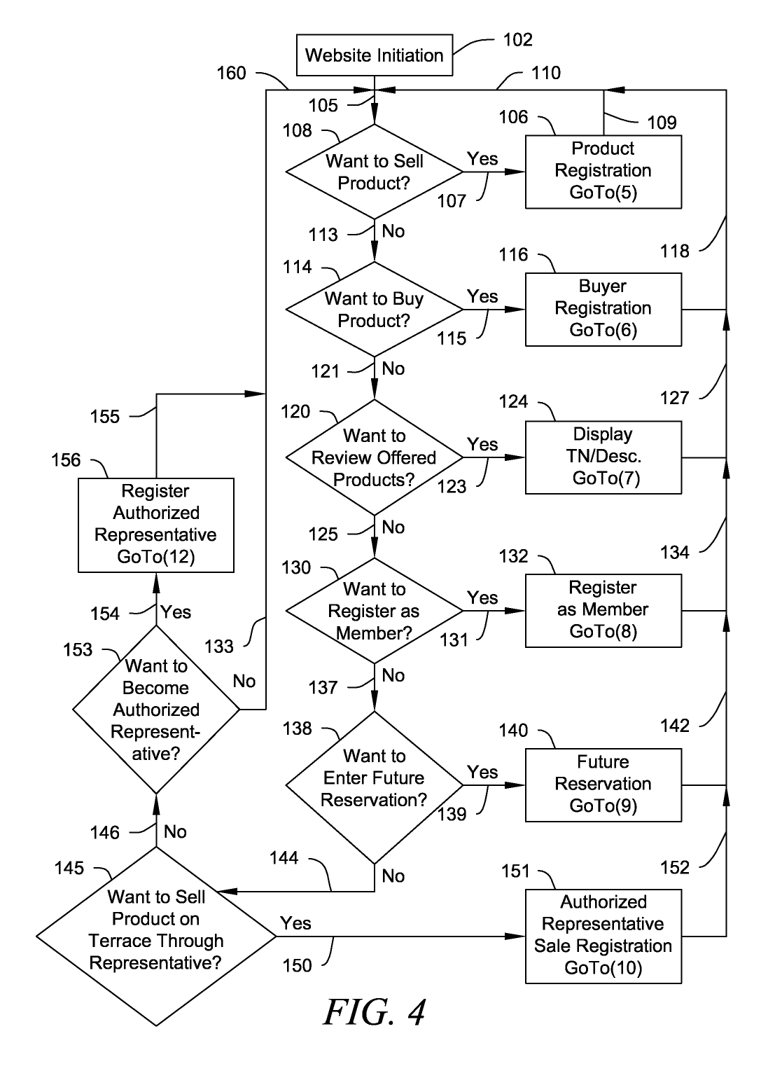

In FIG. 3a, the website server system 100 is shown having central processing unit CPU 71 coupled to input/output units I/O 73, 75 and 77 via communication lines 78, 74 and 76, respectively. The I/O devices 73, 75, and 77 provide input and output information signals to the CPU 71. Terminals T1 81 and T2 83 are coupled to the CPU 71 via communication lines 82 and 84, respectively. Database memory 88 is coupled to the CPU via communication line 89. Additional memory 91 and 93 are coupled to CPU 71 via communication lines 94 and 95, respectively.

FIG. 3a is a block diagram of a server system 100 constructed in accordance with the present invention. In one embodiment, server system 100 comprises a CPU computing device 71; an input and output display subsystem 82 and 83 such as a keyboard or a mouse coupled to a computer display; a data storage 88 such as a hard drive database memory; other data storage 91 and 93 such as memory cards or memory storage; a network connectivity unit internal to the CPU 71 coupled to the Internet 35, communication interface 38 or other network interfaces 39. The memory 88, 91 and 93 hold operating software, web server software, and terrace manager software.

Processing unit 71 comprises a microprocessor capable of executing stored program instructions. Input and output subsystem 82 and 83 (as well as I/O devices 73, 75 and 77) have circuitry for controlling input devices (for example a keyboard controller) and for performing signal conversions (for example, a digital signal processor) upon input data, as well as circuitry for operating upon and outputting data for display, for example a video card with processor, frame buffer, and display driver. Data storage unit 88, 91 and 93 may include both fixed and removable media based on storage technology such as magnetic, optical, or magneto-optical devices. Network connectivity unit in CPU 71 includes hardware and software for data communication in accordance with conventional protocols.

Memory 88, 91 and 93 includes both random access memory (RAM) and read-only memory (ROM), and provides storage for program instructions and data. Within the memory 88, 91 or 93, operating software comprises program instruction sequences for accessing, communicating with, and/or controlling auction server resources Operating software provides a software platform upon which application programs may execute, and web server software comprises program instruction sequences for responding to messages received via the Internet or other network. Terrace manager software comprises program instruction sequences for establishing and managing online terrace sales, product registration, seller registration, price variations based on terrace pricing, buyer registration of the sale. Terrace manager includes a descending bid unit that facilitates or supports descending terrace pricing dictated by the user registering the product.

In an exemplary embodiment of the present invention, terrace manager and server system has a computing device having at least one Intel Pentium IV (Intel Corporation, Santa Clara, Calif.) microprocessor; 2048 megabytes of random access memory (RAM); an internal hard disk drive and redundant drive; and at least one modem or network interface card. Microsoft Windows (Microsoft Corporation Redmond, Wash.) may serve as operating software with Microsoft Internet Information Server serving as web server software.

The database memory 88 maintains the records of the members registered to use the present on-line invention, and the database memory 88, alone or in conjunction with memory MEM1 91 or MEM2 93, are used to coordinate registration, bidding and purchasing processing. The server computer system 100 has a database memory 88 for managing data regarding articles to be exhibited in an auction, and a data base 88 for managing information on users participating in the auction and members registered for the on-line system and service.

The server computer system 100 sends information on an auction to the client computers, user computers, and member computers, and the information on the auction can be sent from the server computer in the form of a Web page written in Hyper Text Markup Language (HTML). The client, user and member computers can display the information on the auction in the form of a Web page, using a World Wide Web (WWW) browser.

The database memory 88 stores personal information on users or members, for example, the ID's, names, addresses, purchase records, credit card numbers, login names and the like of the users. If a user or member has declared his or her intention to participate in an auction through a client computer, the CPU 71 gives a user ID to the user, so that the user ID can be stored in the database 88. The user ID thus given to the user is also sent to his or her client computer through a communication network. It is preferable that a user ID be given to a user as soon as the user has sent certain information on monetary dealings, such as a credit card number from his or her client computer, to the server computer system 100.

The data base 88 can also store data regarding an auction of articles. More specifically, the pictures, features, initial prices, lowest prices, markdowns, and markdown periods of the articles. When a user or member has an article exhibited in an auction, the user can set the initial price, lowest price, markdown and the like of the article. At the outset of an auction, the CPU 71 displays the initial price of an article, together with its picture and features, and accepts bids from users or members. If no user or member has made a bid for the article, information on an auction with a price reduced by the markdown stored in the article database 88 is sent to and displayed by the client computers after the lapse of a predetermined markdown period (which may be set by the user and stored in the database 88).

The present system used a website where professionals, who are knowledgeable about the market, register particular items for the on-line sale process. These professionals work with prospective sellers to identify sale items, take custody of the items to be sold, register and catalogue the sale item on the website, and determine the sale parameters that will be used for each item, such as when and at what price the items will go on sale online, when the item will be taken off the online sale, and the increment of time and schedule of price drops during the sale process.

The process generally works as follows: Agents of the seller register items for the on-line sale of the item. The item will be placed on sale at an initial asking price, and the item will remain at that asking price for a pre-arranged time. If the product has not sold by the end of the initial time frame, the asking price of that product will be reduced by a pre-arranged percentage or amount. This process of reducing the asking price (and waiting) will continue until the product is sold, or removed from the on-line sale. With the present invention, the seller is able to present their product at an optimum price and gradually decrease that price at the pre-arranged “price drop” levels until the product sells or the sale ends. These “price drop” levels can be set as uniform decreases or each “price drop” level can be individually set by the seller.

The “profile” information for the sale of the item input for the seller on the computer management system will include setting seven parameters that include: (1) starting sale price, (2) when the item shall be posted for sale, (3) length of time to first price decrement, (4) length of time between successive price decrements, (5) amount of each price decrement, (6) time of day when decrement occurs, (7) when the item will be taken down from being posted for sale.

After an item is catalogued, an initial asking price will be determined for an item when it will go on-line for sale. The timing for the on-line sale will also be determined and input onto the computer management system. The length of time the item will remain at the initial price will be set, and at the end of the initial time period, the price drop according to the “price drop” level. A published schedule of “price drops” is published showing the date, time and asking price amount of each price drop level. This “price drop” schedule is created by determining the time between each price drop, the amount of each price drop, and the time of day of each scheduled drop. A final price decrement will be set that establishes a floor below which the sale price of the item will not fall, and the timing for taking the product off the on-line sale website will be established.

Each profile item input onto the computer management system for each sale item is explained below as follows:

1. Starting price: The asking price at which an item or items will first appear online will be input onto the computer management system by the professional who registered the item on the database. This price will be determined based on discussions with the owner of the item, which many be determined by the contractual agreement between them. Because items will drop from this starting price, most items will having a starting price that is above the “expected market value” or end sale price.

2. When to place item online: A time and date must be established as to when an item is to go online, and items (or groups of items) can be scheduled to go online immediately upon registration or at a later time as dictated by what is input onto the computer management system. This “on-line” sale initiation can be done manually or scheduled to start at a predetermined time, but the computer management system will regulate and initiate the initiation of the on-line sale.

3. Length of first price decrement: After an item or items go live online, there will be a length of time before the first price decrease or “price drop.” This length of time should be input into the computer management system by the professional who catalogued the item. In most cases, this first increment will be longer than the timing of the price drops that follow. The initial price drop timing should be long enough to allow as many buyers as possible to find the item, but not long enough that prospective buyers become disinterested. An algorithm will help to determine this time based on page views and other metrics.

4. Time between individual price drops: A schedule of subsequent price drops must be input onto the computer management system, which creates a “price drop” schedule for publication. Although the present system will allow for any timing schedule between incremental price drops, in most instances, the price drops can be dictated by the items being sold. As an example, after the first price increment, it is dictated that the price of the item will drop every 14 days for 4 increments. This will allow more people to discover the item online and the price drops are far enough apart that the buyer may not see a reason to wait for another incremental drop before purchasing. If the artwork is not purchased by the end of the aforementioned two month cycle, the schedule can be speeded up so the prices will drop every 7 days until the item is sold or it has reached its lowest price increment. This will speed up the process on an item that was not important enough for a collector to acquire at an earlier price increment.

5. Amount of each price drop (specific amount or %) The user will input the amount of each incremental price drop for an item into the computer management system. Although the amount of each incremental price drop of an item or items in the system does not need to be the same, it is probably best that they are. The price drops can be specific amounts or a percentage of what the price was at the previous asking price level. Example 1: An item goes live online and it is determined that at each price reduction increment, the price will be reduced by 10% of its current price. Example 2: It is determined that the first 6 incremental price drops, the price of the item will be reduced by $1,000. Then the item will be reduced in increments of 10% until the item is sold or reaches its lowest established increment.

6. Time of day each price drop occurs: The user needs to input the time of day each incremental price drop will occur onto the computer management system. Although each incremental price drop in the system can occur at any time of day or night, it is important they remain consistent for a specific item or group of items that are part of an on-going on-line sale. Example: An item is to be placed online. Because the most likely purchaser lives on the east coast of the U.S.A. and is likely to go to lunch at 12:00 pm est, the item's drop time may be scheduled for 11:00 am cst so the most likely buyers will be free at the moment of drop and they can still make lunch after the purchase.

7. Final pricing: The user will input onto the computer management system an incremental level an item will be taken off it on-line sale status. Items that have reached their lowest timed price increment will be taken off the on-line sale website by the computer management system and those items may be returned to the owner or consignor, placed back on live status at a later date, or placed onto a different sale site.

For the sake of transparency, price drop intervals are published on a price reduction schedule. An example of a published table of price drops is shown below. If not purchased before a particular price drop occurs, the exact moment of each price drop and the expiratory date line will disappear so the current price cycle will move to the top. The example table published on the website shows a 10% price reduction every 14 days.

Published Price Decrement Table: Product Item “A”

| Start Date: | Start Time: | Start Price: |
|---|---|---|
| 1/10/12 | 1:00 pm cst | $10,000 |
| 1/24/2012 | 1:00 pm cst | $9,100.00 Buy |
| 2/7/2012 | 1:00 pm cst | $8,190.00 Reserve |
| 2/21/2012 | 1:00 pm cst | $7,371.00 Reserve |
| 3/6/2012 | 1:00 pm cst | $6,633.90 Reserve |
| 3/20/2012 | 1:00 pm cst | $5,970.51 Reserve |
| 4/3/2012 | 1:00 pm cst | $5,373.46 Reserve |

Bid information from the client computers can be received by the interface in CPU 71 that is coupled through the communication network 39, 38 or 35. The CPU 71 sends information on the confirmation of a terrace pricing purchaser and performs the terrace price decrements as specified by the user. The CPU 71 sends a Web page announcing the interruption of biddings to the client computers of the other participants, so that the client computers display the Web page.

Communications to and from the system are regulated by the CPU 71 through the I/O 77, 75 or 73, or in the alternative, through the interface 37 coupled to the CPU 71 and the Internet 35, outside network connection NET 39, or communication interface INT 38.

As shown in FIG. 3b, the present invention supports a system and method for providing connectivity of a mobile node 105 to one or more sources of information associated with a venue or event so as to provide variable selected information and media transmissions to the mobile node. The mobile node 100 includes a hand-held mobile unit 105 that includes a processor, memory and a power source, as well as a transceiver and antenna 110.

The transceiver and antenna 110 supports radio transmission communications 125 to radio transceiver antenna(s) 165 coupled associated with a venue 155 or coupled to a telecommunications system that supports connectivity to the Internet 175 or another network without interfacing directly with equipment components located at venue 150.

The radio transceiver antenna(s) 165 may be coupled to the Internet 175 via a connection 170, and the Internet 175 may be coupled to one or more servers SRV2 185 via connection 180. The mobile hand-held unit 105 may also be connected to SRV2 185 via a separate connection 122, which can include a wireless radio connection or a wireline communication system connection. The server SRV2 185 is capable of maintaining the webpages that support the applications program download for the present invention, as well as supporting the interaction of communications with the mobile node after launch of the applications program and selection of the activity, venue, sport or team requested by the hand-held mobile node 105.

An applications program can be downloaded to the hand-held mobile unit that supports an interface with an applications gateway. Access to the gateway application is through a hand-held mobile unit, which can include a mobile phone, smartphone device, or portable computer having a wireless radio transmission connection at the above-identified venue location. (e.g. iPhone, Droid, iPad, Slate, etc.).

The gateway application is programmed in an application software that can be/is utilized by the hand held or portable devices in whatever programming language the said device utilizes to operate the gateway application and then utilizes the wireless communication networks(s) available to that device in that area or any other area where the gateway application can operate in using the functions and/or features of said gateway application.

FIG. 3b provides a more detailed explanation of the system components available at the venue 150. The mobile node 100 includes a hand-held mobile unit 105 that includes a processor, memory and a power source, as well as a transceiver and antenna 110. The transceiver and antenna 110 supports radio transmission communications 125 (e.g. WiFi, cellular, GSM, Evdo, 4G/LTE, CDMA, or others) to an radio transceiver antenna 165, which is coupled via connection 205 to a radio transmission network 210 associated with a venue 155. It is also possible for the mobile hand-held unit 105 to be coupled to the radio transceiver antenna 165 and a radio transmission network that is coupled to a telecommunications system that supports connectivity to the Internet 175 or another system network without interfacing directly with equipment or components at venue 150.

The radio transmission network 210 is coupled to a base station transceiver unit 220 via connection 215, where the base station transceiver station provides an interface between radio domain communications and data communications carried over a telecommunications or network computer system. The base station transceiver unit 220 is coupled to a gateway 230 for the network at the venue 150 via connection 225, which provides an interface with the network maintained at the venue 150 or associated with the venue 150.

The home agent 240 is coupled to the Internet 175 via a connection 170, and the Internet 175 may be coupled to one or more servers SRV2 185 via connection 180. The mobile hand-held unit 105 may also be connected to SRV2 185 via a separate connection 122, which can include a wireless radio connection or a wireline communication system connection. The server SRV2 185 is capable of maintaining the webpages that support the applications program download for the present invention, as well as supporting the interaction of communications with the mobile node after launch of the applications program.

FIG. 3b provides a more detailed explanation of the system components available at the venue 150 and a second venue 192. The mobile node 100 includes a hand-held mobile unit 105 that includes a processor, memory and a power source, as well as a transceiver and antenna 110. The transceiver and antenna 110 supports radio transmission communications 125 to a radio transceiver antenna 165, which is coupled via connection 205 to a radio transmission network 210 associated with a venue 155. It is also possible for the mobile hand-held unit 105 to be coupled to the radio transceiver antenna 165 and a radio transmission network that is coupled to a telecommunications system that supports connectivity to the Internet 175 or another system network without interfacing directly with equipment or components at venue 150.

The transceiver antenna 165 and the radio transmission network 210 are coupled to a base station transceiver unit 220 via connection 215, where the base station transceiver station provides an interface between radio domain communications and data communications carried over a telecommunications or network computer system. The base station transceiver unit 220 is coupled to a gateway 230 for the network via connection 225. The gateway 230 is coupled to a home agent 240 via connection 235, where the home agent 240 controls communication flow and directions on the network maintained at the venue 150 or associated with the venue 150. The home agent 240 is coupled to a computer server SRV1 250 via connection 245.

The present invention has is a communication system supporting the processing communications from a mobile unit comprising a home agent network associated with a first venue and having a home agent coupled to a computer server, said home agent processing communications received from said mobile unit, a transceiver unit coupled to said home agent for receiving and transmitting communications to said mobile unit, and said home agent processes communications from said mobile unit including selected venue-specific requests for information and data relating to said first venue or venue-specific ordering information relating to said first venue.

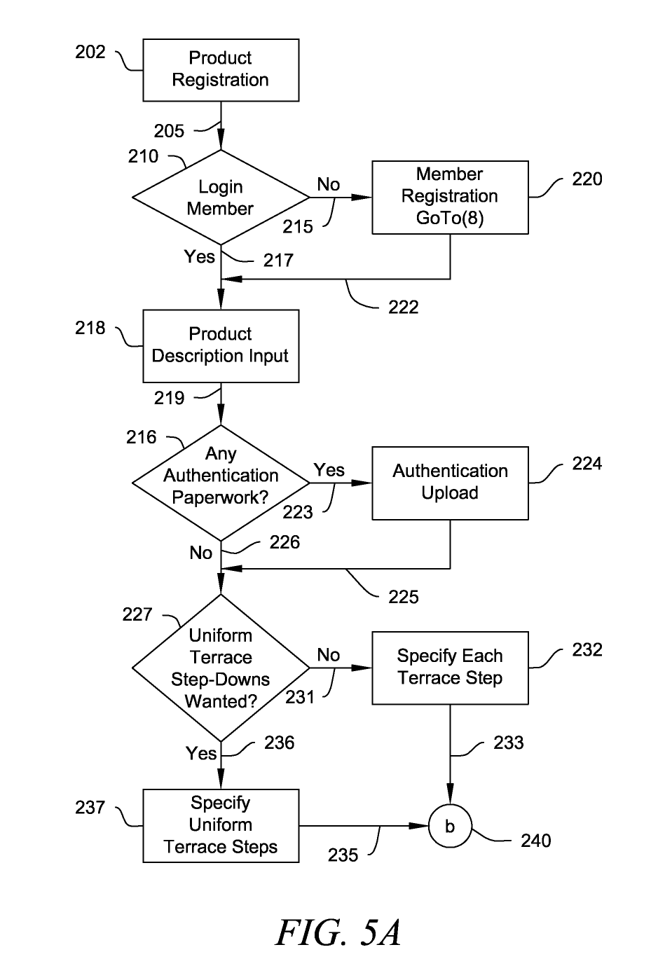

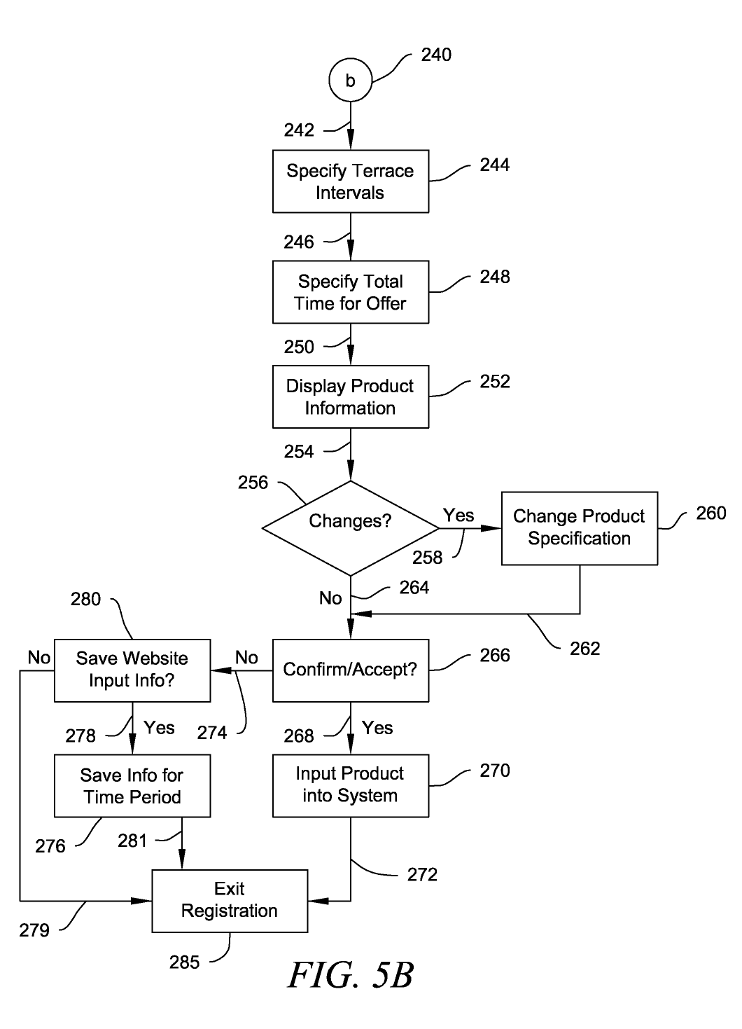

As shown in FIG. 4, the website initiation process begins at Initiation Step 102, which proceeds to Question Step 108 through transition step 105. At Question Step 108, the process asks the question of whether the user wants to sell a product. If the answer is yes to this query at Question Step 108, the process proceeds to Process Step 106 through transition step 107 for the product registration steps. At Process Step 106, the process proceeds as shown in FIG. 5. After Process Step 106, the process proceeds to Question Step 108 through transition steps 109, 110, and 105.

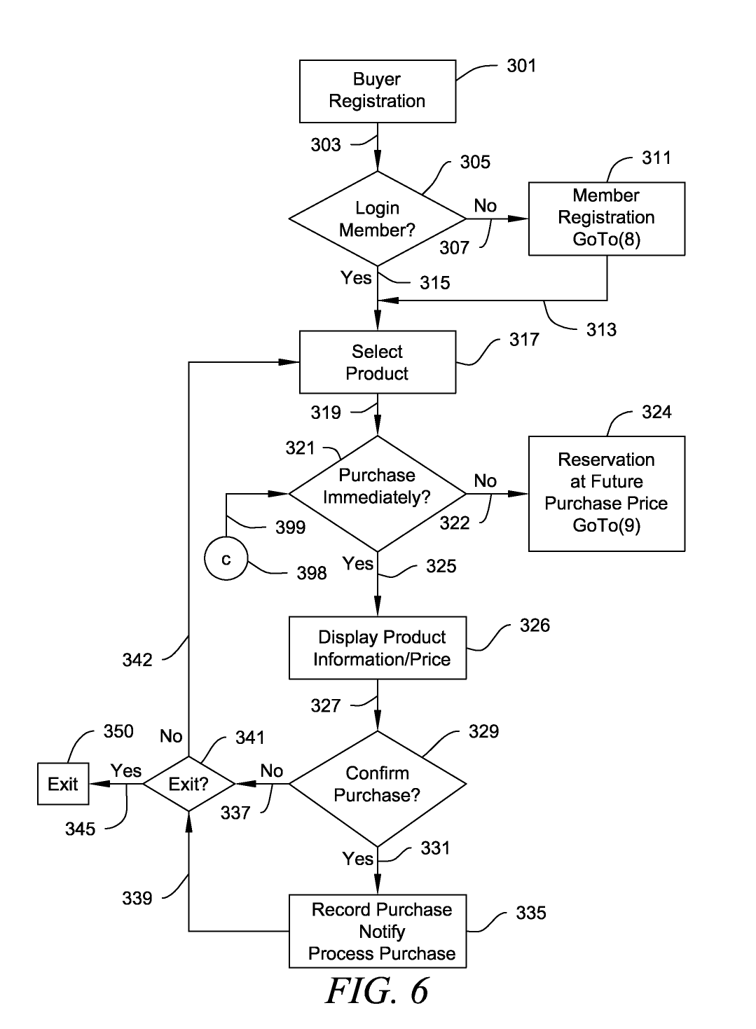

If a no response is given in Question Step 108, the process proceeds to Question Step 114 through transition step 113 where the user is asked whether it wants to buy a registered product listed on the on-line system. If the answer is yes to this query at Question Step 114, the process proceeds to Process Step 116 through transition step 115 for the buyer registration process steps. At Process Step 116, the process proceeds as shown in FIG. 6. After Process Step 116, the process proceeds to Question Step 108 through transition steps 118, 110, and 105.

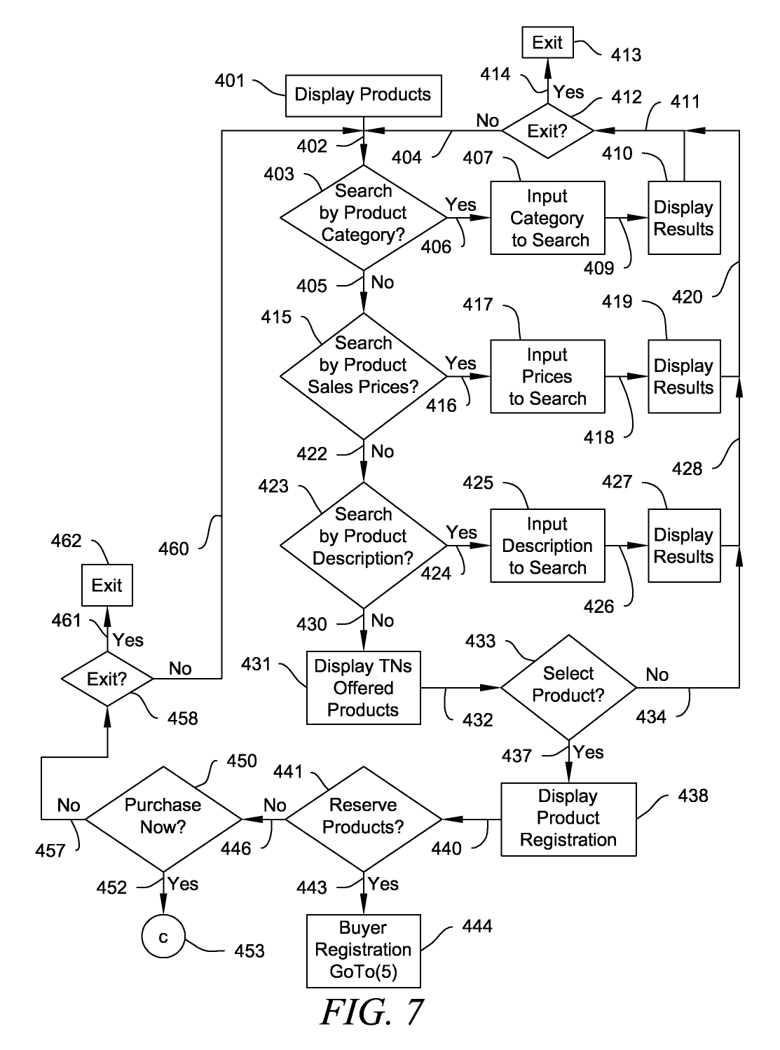

If the answer to the query at Step 114 is no, the process proceeds to Question Step 120 through transition step 121 where the user is asked whether it wants to review offered products on the on-line system. If the answer to this query is yes at Step 120, the process proceeds to Process Step 124 through transition step 123 where the products are displayed as set forth in FIG. 7. After the completion of Process Step 124, the process proceeds to Question Step 108 through transition steps 127, 118, 110, and 105.

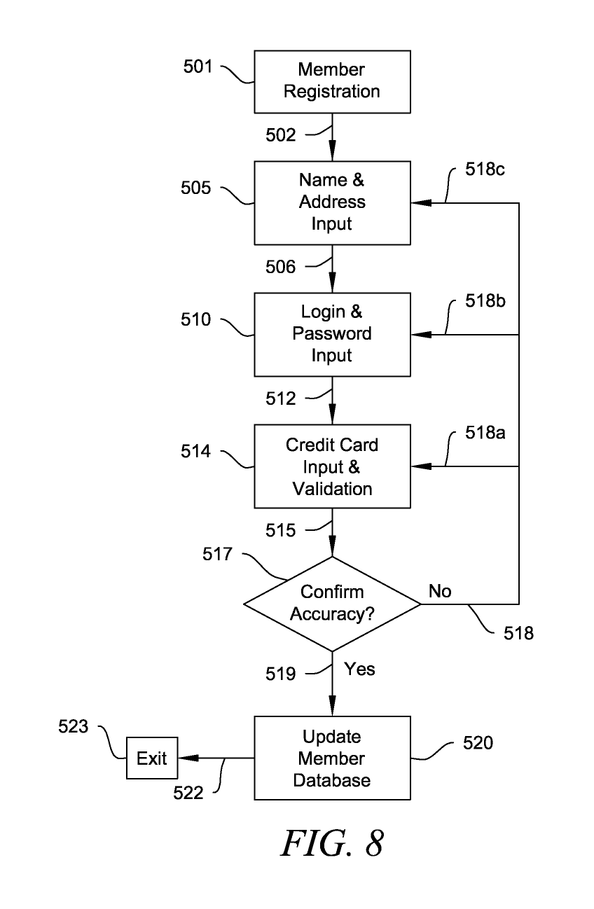

If the answer to the query in Step 120 is no, the process proceeds to Question Step 130 through transition step 125 where the user is asked if it wants to register as a member to the on-line system. If the answer to the question at Step 130 is yes, the process proceeds to Process Step 132 through transition step 131 where the member registration is progressed as shown in FIG. 8. After process Step 132, the process proceeds to Question Step 108 through transition steps 134, 127, 118, 110, and 105.

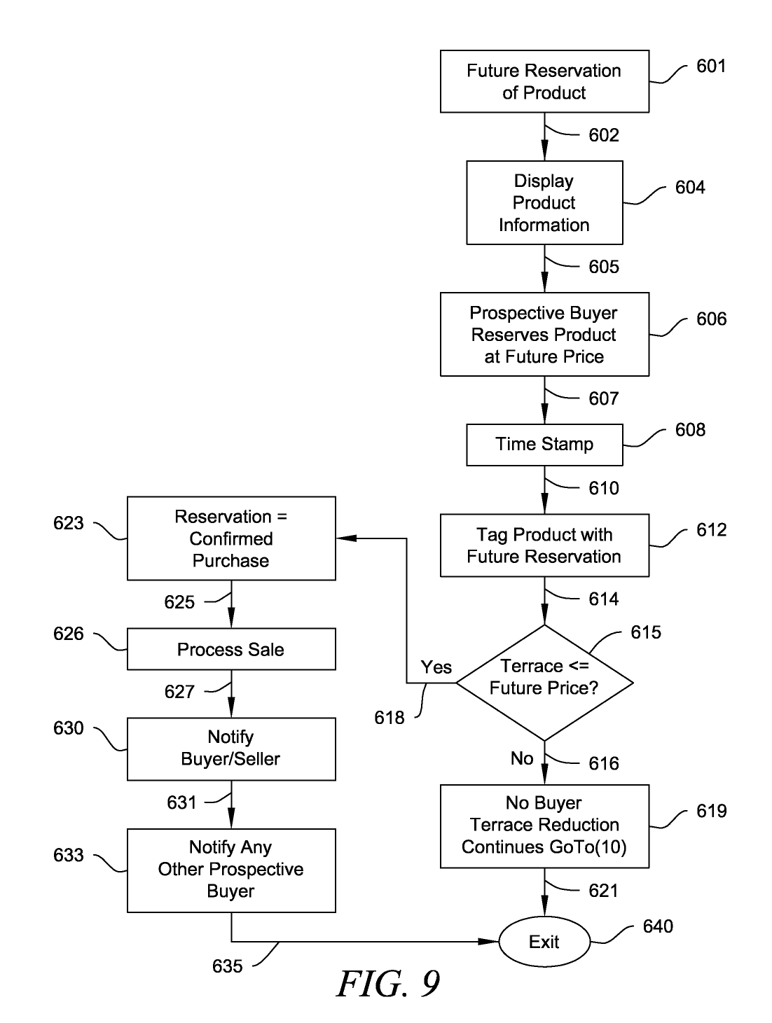

If the answer to question at Step 130 is no, the process proceeds to Question Step 138 through transition step 137 where the user is asked if it wants to enter a future reservation for the potential purchase of an item. If the answer to the query at Step 138 is yes, the process proceeds to Process Step 140 through transition step 139 where the future reservation is entered pursuant to the procedures set forth in FIG. 9. After the conclusion of Step 140, the process proceeds to Question Step 108 through transition steps 142, 134, 127, 118, 110, and 105.

If the answer is no to Question Step 138, the process proceeds to Question Step 145 through transition step 144 where the user is asked if it wants to sell an article through an authorized representative. If the answer to the query at Question Step 145 is yes, the process proceeds to Process Step 151 through transition step 150 where the product registration with an authorized representative procedure is followed. After the completion of Process Step 151, the process proceeds to Question Step 108 through transition steps 152, 160, and 105.

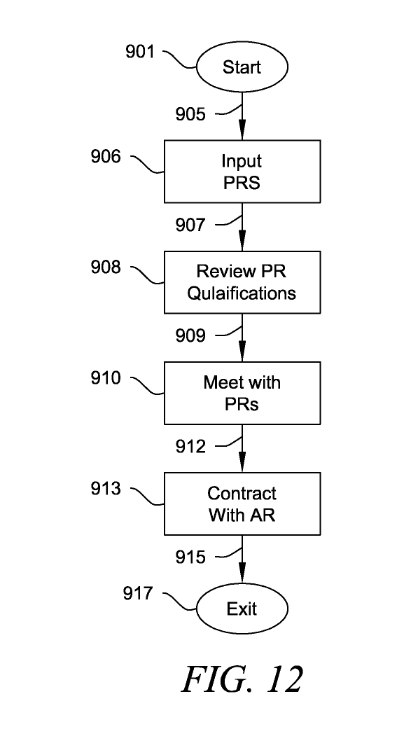

If the answer to Question Step 145 is no, the process proceeds to Question Step 153 through transition step 146 where the program asks the user if it wants to become an authorized representative. If the answer to this query is yes at Question Step 153, the process proceeds to Process Step 156 through transition step 154 where the authorized representative registration occurs pursuant to the procedure steps shown in FIG. 12. After the completion of process step 156, the process proceeds to Question Step 108 through transition steps 155, 133, 160, and 105.

If the answer to the Question Step 156 is no, the process proceeds to Question Step 108 through transition steps 133, 160, and 105. While these process and question steps are shown in sequential or as consecutive steps, the process and question steps can be posed in a parallel fashion with each question and answer being subject to a parallel selection by the user on a webpage that others one or more selections simultaneously to the user for selection.

As shown in FIG. 5A, the product registration process begins at Initiation Step 202, which proceeds to Question Step 210 through transition step 205. At Question Step 210, the process asks the user to input membership information to log into the on-line system so as to access sections permitted for members. If the user is not a registered member, the process will proceed from Question Step 210 to Process Step 220 through transition step 215 where the user can register as a member to the on-line system as shown in the process steps of FIG. 8. After the conclusion of Process Step 220, the process proceeds to Process Step 218 through transition steps 222 and 217.

If the user successfully logs into the computer management system in Question Step 210, the process proceeds to Process Step 218 through transition step 217 where the user inputs the product description into the system. After Process Step 218, the process proceeds to Question Step 216 through transition step 219 where the user is asked if there is any authentication paperwork needs to be placed uploaded onto the system database in association with the product being registered.

If the answer to the query in Question Step 216 is yes, the process proceeds to Process Step 224 through transition step 223 where the system supports the uploading of the authentication paperwork associated with the product. After Process Step 224, the process proceeds to Question Step 227 through transition steps 225 and 226. If the answer to the query at Question Step 216 is no, the process proceeds to Question Step 227 through transition step 226.

At Question Step 227, the process asks the user if there is a desire to set uniform “step down” amounts that are terraced from the initial price offering for the product being registered. If the answer to the query at Question Step 227 is no, the process proceeds to Process Step 232 through transition step 231 where the user sets the initial terrace price level and all subsequent terrace “step down” amounts. After Process Step 232, the process to “b” at Step 240 through transition step 233 where the program transitions to the process steps shown on FIG. 5b.

If the answer to the query at Question Step 227 is yes, the process proceeds to Process Step 237 through transition step 236 where the user sets the initial terrace price level and the uniform terrace “step down” amounts. After Process Step 237, the process to “b” at Step 240 through transition step 235 where the program transitions to the process steps shown on FIG. 5b. While these process and question steps are shown in sequential or as consecutive steps, the process and question steps can be posed in a parallel fashion with each question and answer being subject to a parallel selection by the user on a webpage that others one or more selections simultaneously to the user for selection.

As shown in FIG. 5B, the product registration process continues at continuation “b” on step 240, which proceeds to Process Step 244 through transition step 242. At Process Step 244, the process asks the user to specify the time intervals for each terrace “step down” in the pricing offered on the system for the product registered for sale.

After Process Step 244, the process proceeds to Process Step 248 through transition step 246. At Process Step 248, the process asks the user to specify the total time the registered product will be offered for sale on the system.

After Process Step 248, the process proceeds to Process Step 252 through transition step 250. At Process Step 252, the process will display the entered product information as entered by the user. A photograph of the product registered can also be displayed with the pricing terraces, the timing for each “step down” in the price offering, and the total sale time for the product offering on the system.

For the sake of transparency, price drop intervals are published on a price reduction schedule. The top part of the schedule will always be visible on the product page of the on-line website. An example of a published table of price drops is shown below. If not purchased before a particular price drop occurs, the exact moment of each price drop and the expiratory date line will disappear so the current price cycle will move to the top. The example table published on the website shows a 10% price reduction every 14 days.

Published Price Decrement Table: Product Item “A”

| Start Date: | Start Time: | Start Price: |
|---|---|---|
| 1/10/12 | 1:00 pm cst | $10,000 |
| 1/24/2012 | 1:00 pm cst | $9,100.00 Buy |
| 2/7/2012 | 1:00 pm cst | $8,190.00 Reserve |
| 2/21/2012 | 1:00 pm cst | $7,371.00 Reserve |
| 3/6/2012 | 1:00 pm cst | $6,633.90 Reserve |
| 3/20/2012 | 1:00 pm cst | $5,970.51 Reserve |
| 4/3/2012 | 1:00 pm cst | $5,373.46 Reserve |

With the present on-line system, all items published for sale on the website will be sold on a first commitment basis. No one will be able to purchase an item at a price below the current asking price setting. A buyer will be able to make a future “reserve” commitment to buy an item after a specific price drop date and time occurs. When the reserve is set, the purchaser will be shown to have reserved the item at the moment the future price drop level. If someone does not purchase the item before that decrement in price, the person setting the reserve commitment will be shown to have bought or purchased the item.

If a person makes a future reserve commitment at one of the visible “price drop” levels, all of the published decrements below the reserved one can be removed from the “price drop” list or the word “Reserve” can be placed on those lower “price drop” levels. For example, if a person enters a “reserve” commitment on an item listed for a “price drop” at Mar. 6, 2012 at 1:00 pm cst for $6,633.90, that person will click on the reserve tab on that line and then register to purchase the work at that asking price. The buyer has to submit to the computer management system all their contact and credit card information, with a contractually binding commitment to purchase.

When finished and credit limit is confirmed on their credit card, all the times under that date will be removed from the table or listed as reserved. If no one purchases the item before the date and time of the reserved commitment decrement, the item will be purchased by the person who reserved it at that level. After the person has entered a reserve commitment onto the computer management system for the item at a specific price decrement level, another person can purchase the product item before the asking price is reduced to that specific price decrement level or place a reserve price commitment at a price above the highest reserved price decrement level.

In the above example, another person can place a reserve price commitment at Feb. 7, 2012 at 1:00 pm cst for $8,190.00, which is above the highest reserve pricing level for Mar. 6, 2012 of $6633.90. After this second person places a reserve commitment for the Feb. 7, 2012 price decrement, the present invention will inform the person who placed the reserve commitment at Mar. 6, 2012 at 1:00 pm cst for $6,633.90 that someone has committed to purchase the work at Feb. 7, 2012 at 1:00 pm cst for $8,190.00. The system will inquire if that person would like to purchase the work at the current price or place a higher reserve commitment price.

In this manner, purchasers can place advanced future reserve commitments significantly below a current asking price for a particular product item. When a potential buyer tries to place a reserve commitment at the same level, they are told that such an action is conflicted by a prior reserve commitment at that price level. The new buyer then has to decide whether to place a higher reserve commitment than previously entered in to the computer management system. The seller is also notified about reservations and sales of product.

After Process Step 252, the process proceeds to Question Step 256 through transition step 254. At Question Step 256, the process asks the user if there are any changes that need to be made to the product information entered by the user, the pricing terraces, the timing for each “step down” in the price offering, and the total sale time for the product offering on the system.

If the answer to the query in Question Step 256 is yes, the process proceeds to Process Step 260 through transition step 258. At Process Step 260, the process allows the user to change the various information relating to the registered product, which can include the pricing terraces, the timing for each “step down” in the price offering, and the total sale time for the product offering on the system. After Process Step 260, the process proceeds to Question Step 266 through transition steps 262 and 264. If the answer to Question Step 256 is no, the process proceeds to Question Step 266 through transition step 264.

At Question Step 266, the process asks the user to confirm and/or accept the entered product information for the product sought to be registered, which can include the pricing terraces, the timing for each “price drop” in the price offering, and the total sale time for the product offering on the system. If the answer to Question Step 266 is yes confirming the accuracy of the entered information, the process proceeds to Process Step 270 through transition step 268. At Process Step 270, the process enters all the product information as entered by the user onto the computer management system, including the “price drop,” the timing for each “step down” in the price offering, and the total sale time for the product offering on the system.

The “profile” information for the sale of the item input for the seller on the computer management system will include setting seven parameters that include: (1) starting sale price, (2) when the item shall be posted for sale, (3) length of time to first price decrement, (4) length of time between successive price decrements, (5) amount of each price decrement, (6) time of day when decrement occurs, (7) when the item will be taken down from being posted for sale.

After an item is catalogued, an initial asking price will be determined for an item when it will go on-line for sale. The timing for the on-line sale will also be determined and input onto the computer management system. The length of time the item will remain at the initial price will be set, and at the end of the initial time period, the price drop according to the “price drop” level. A published schedule of “price drops” is published showing the date, time and asking price amount of each price drop level. This “price drop” schedule is created by determining the time between each price drop, the amount of each price drop, and the time of day of each scheduled drop. A final price decrement will be set that establishes a floor below which the sale price of the item will not fall, and the timing for taking the product off the on-line sale website will be established.

Each profile item input onto the computer management system for each sale item is explained below as follows:

1. Starting price: The asking price at which an item or items will first appear online will be input onto the computer management system by the professional who registered the item on the database. This price will be determined based on discussions with the owner of the item, which many be determined by the contractual agreement between them. Because items will drop from this starting price, most items will having a starting price that is above the “expected market value” or end sale price.

2. When to place item online: A time and date must be established as to when an item is to go online, and items (or groups of items) can be scheduled to go online immediately upon registration or at a later time as dictated by what is input onto the computer management system. This “on-line” sale initiation can be done manually or scheduled to start at a predetermined time, but the computer management system will regulate and initiate the initiation of the on-line sale.

3. Length of first price decrement: After an item or items go live online, there will be a length of time before the first price decrease or “price drop.” This length of time should be input into the computer management system by the professional who catalogued the item. In most cases, this first increment will be longer than the timing of the price drops that follow. The initial price drop timing should be long enough to allow as many buyers as possible to find the item, but not long enough that prospective buyers become disinterested. An algorithm will help to determine this time based on page views and other metrics.

4. Time between individual price drops: A schedule of subsequent price drops must be input onto the computer management system, which creates a “price drop” schedule for publication. Although the present system will allow for any timing schedule between incremental price drops, in most instances, the price drops can be dictated by the items being sold. As an example, after the first price increment, it is dictated that the price of the item will drop every 14 days for 4 increments. This will allow more people to discover the item online and the price drops are far enough apart that the buyer may not see a reason to wait for another incremental drop before purchasing. If the artwork is not purchased by the end of the aforementioned two month cycle, the schedule can be speeded up so the prices will drop every 7 days until the item is sold or it has reached its lowest price increment. This will speed up the process on an item that was not important enough for a collector to acquire at an earlier price increment.

5. Amount of each price drop (specific amount or %) The user will input the amount of each incremental price drop for an item into the computer management system. Although the amount of each incremental price drop of an item or items in the system does not need to be the same, it is probably best that they are. The price drops can be specific amounts or a percentage of what the price was at the previous asking price level. Example 1: An item goes live online and it is determined that at each price reduction increment, the price will be reduced by 10% of its current price. Example 2: It is determined that the first 6 incremental price drops, the price of the item will be reduced by $1,000. Then the item will be reduced in increments of 10% until the item is sold or reaches its lowest established increment.

6. Time of day each price drop occurs: The user needs to input the time of day each incremental price drop will occur onto the computer management system. Although each incremental price drop in the system can occur at any time of day or night, it is important they remain consistent for a specific item or group of items that are part of an on-going on-line sale. Example: An item is to be placed online. Because the most likely purchaser lives on the east coast of the U.S.A. and is likely to go to lunch at 12:00 pm est, the item's drop time may be scheduled for 11:00 am cst so the most likely buyers will be free at the moment of drop and they can still make lunch after the purchase.

7. Final pricing: The user will input onto the computer management system an incremental level an item will be taken off it on-line sale status. Items that have reached their lowest timed price increment will be taken off the on-line sale website by the computer management system and those items may be returned to the owner or consignor, placed back on live status at a later date, or placed onto a different sale site. After Process Step 270, the process proceeds to Exit Step 285 through transition step 272 where the registration subroutine exits.

If the answer to Question Step 266 is no, the process proceeds to Question Step 280 through transition step 274. At Question Step 280, the process asks the user if it wishes to save the input product information on the system until a later time when it can be confirmed and formally entered into the on-line system. If the answer to Question Step 280 is yes, the process proceeds to Process Step 276 through transition step 278. At Process Step 276, the process saves the entered information about the product, including entered product information with the pricing terraces, the timing for each “price drop” in the asking price, and the total sale time for the product offering on the system. After Process Step 276, the process proceeds to Exit Step 285 through transition step 281.

If the answer to the Question Step 280 is no, the process proceeds to Exit Step 285 through transition step 279 where the product registration routine ends. While these process and question steps are shown in sequential or as consecutive steps, the process and question steps can be posed in a parallel fashion with each question and answer being subject to a parallel selection by the user on a webpage that others one or more selections simultaneously to the user for selection.

As shown in FIG. 6, the buyer registration process begins at Initiation Step 301, which proceeds to Question Step 305 through transition step 303. At Question Step 305, the process asks the user to input membership information to log into the on-line system so as to access sections permitted for members. If the user is not a registered member, the process will proceed from Question Step 305 to Process Step 311 through transition step 307 where the user can register as a member to the on-line system as shown in the process steps of FIG. 8. After the conclusion of Process Step 311, the process proceeds to Process Step 317 through transition steps 313 and 315.

If the user successfully logs into the system in Question Step 305, the process proceeds to Process Step 317 through transition step 315. At Process Step 317, the process asks the user to select the product the user wish to purchase or place a reservation at a future price. Once the user selects a product in Process Step 317, the process proceeds to Question Step 321 through transition step 319. At Question Step 321, the process asks the user if it wishes to purchase the selected product immediately.

At “c” Continuation Step 398, the process proceeds to Question Step 321 through transition step 399 to Question Step 321 where the process asks the user if it wishes to purchase the selected product immediately.

If the answer to Question Step 321 is no that there is no desire to purchase immediately, the process proceeds to Process Step 324 through transition step 322 where the user places a reservation of a future price offering for the selected product pursuant to the steps in FIG. 9. On the other hand, if the answer to the query in Question Step 321 is yes that there is a desire to purchase immediately, the process proceeds to Process Step 326 through transition step 325. At Process Step 326, the process displays the product information including purchase price. Compared to known systems, the present invention allows considerably more time for all interested parties to view the product and decide if they want to pursue it and at what price or reservation level. The present invention also allows potential buyers worldwide the opportunity to participate, thus increasing the potential of selling the product at the maximum price.

After Process Step 326, the process proceeds to Question Step 329 through transition step 327. At Question Step 329, the process asks the user to confirm the purchase of the displayed product. If the answer to Question Step 329 is yes that the purchase is confirmed, the process proceeds to Process Step 335 through transition step 331. At Process Step 335, the process records the purchase, process payment for the purchase through a payment system or credit card transaction, and notifies the purchasers, sellers and bidders of the purchase.

For the sake of transparency, price drop intervals are published on a price reduction schedule. An example of a published table of price drops is shown below. If not purchased before a particular price drop occurs, the exact moment of each price drop and the expiratory date line will disappear so the current price cycle will move to the top. The example table published on the website shows a 10% price reduction every 14 days.

Published Price Decrement Table: Product Item “A”

| Start Date: | Start Time: | Start Price: |
|---|---|---|
| 1/10/12 | 1:00 pm cst | $10,000 |
| 1/24/2012 | 1:00 pm cst | $9,100.00 Buy |
| 2/7/2012 | 1:00 pm cst | $8,190.00 Reserve |
| 2/21/2012 | 1:00 pm cst | $7,371.00 Reserve |
| 3/6/2012 | 1:00 pm cst | $6,633.90 Reserve |
| 3/20/2012 | 1:00 pm cst | $5,970.51 Reserve |
| 4/3/2012 | 1:00 pm cst | $5,373.46 Reserve |

With the present on-line system, all items published for sale on the website will be sold on a first commitment basis. No one will be able to purchase an item at a price below the current asking price setting. A buyer will be able to make a future “reserve” commitment to buy an item after a specific price drop date and time occurs. When the reserve is set, the purchaser will be shown to have reserved the item at the moment the future price drop level. If someone does not purchase the item before that decrement in price, the person setting the reserve commitment will be shown to have bought or purchased the item.

If a person makes a future reserve commitment at one of the visible “price drop” levels, all of the published decrements below the reserved one can be removed from the “price drop” list or the word “Reserve” can be placed on those lower “price drop” levels. For example, if a person enters a “reserve” commitment on an item listed for a “price drop” at Mar. 6, 2012 at 1:00 pm cst for $6,633.90, that person will click on the reserve tab on that line and then register to purchase the work at that asking price. The buyer has to submit to the computer management system all their contact and credit card information, with a contractually binding commitment to purchase.

When finished and credit limit is confirmed on their credit card, all the times under that date will be removed from the table or listed as reserved. If no one purchases the item before the date and time of the reserved commitment decrement, the item will be purchased by the person who reserved it at that level. After the person has entered a reserve commitment onto the computer management system for the item at a specific price decrement level, another person can purchase the product item before the asking price is reduced to that specific price decrement level or place a reserve price commitment at a price above the highest reserved price decrement level.

In the above example, another person can place a reserve price commitment at Feb. 7, 2012 at 1:00 pm cst for $8,190.00, which is above the highest reserve pricing level for Mar. 6, 2012 of $6633.90. After this second person places a reserve commitment for the Feb. 7, 2012 price decrement, the present invention will inform the person who placed the reserve commitment at Mar. 6, 2012 at 1:00 pm cst for $6,633.90 that someone has committed to purchase the work at Feb. 7, 2012 at 1:00 pm cst for $8,190.00. The system will inquire if that person would like to purchase the work at the current price or place a higher reserve commitment price.

In this manner, purchasers can place advanced future reserve commitments significantly below a current asking price for a particular product item. When a potential buyer tries to place a reserve commitment at the same level, they are told that such an action is conflicted by a prior reserve commitment at that price level. The new buyer then has to decide whether to place a higher reserve commitment than previously entered in to the computer management system. The seller is also notified about reservations and sales of product.

After Process Step 335, the process proceeds to Question Step 341 through transition step 339. Also, if the answer to Question Step 329 is no, the process proceeds to Process Step 341 through transition step 337. At Question Step 341, the process asks the user if it wishes to exit the system. If the answer to the query at Step 341 is yes, the process proceeds to Exit Step 350 through transition step 345 where the system exits this subroutine. If the answer to the query at Step 341 is no, the process proceeds to Step 317 through transition step 342 where the product is selected.

While these process and question steps are shown in sequential or as consecutive steps, the process and question steps can be posed in a parallel fashion with each question and answer being subject to a parallel selection by the user on a webpage that others one or more selections simultaneously to the user for selection.

As shown in FIG. 7, the display products process begins at Initiation Step 401, which proceeds to Question Step 403 through transition step 402. At Question Step 403, the process asks the user if it wishes to search by product category. If the answer to the query at Question Step 403 is yes, the process proceeds to Process Step 407 through transition step 406.

At Process Step 407, the process inputs the user's designation of product categories to search and the system searches for the products most closely matching the product category search request input by the user. After Process Step 407, the process proceeds to Process Step 410 through transition step 409 where the products most closely matching the product category search terms input by the user are displayed. After Process Step 410, the process proceeds to Question Step 412 through transition step 411.

If the answer to Question Step 403 is no, the process proceeds to Question Step 415 through transition step 405. At Question Step 415, the process asks the user if it wishes to search for products by sales prices. If the answer to Question Step 415 is yes, the process proceeds to Process Step 417 through transition step 416.

At Process Step 417, the user inputs the sales prices it wishes to search the system and the system searches for the products most closely matching the pricing request input by the user. After Process Step 417, the process proceeds to Process Step 419 through transition step 418 where the products most closely matching the price terms input by the user are displayed. After Process Step 419, the process proceeds to Question Step 412 through transition steps 420 and 411.

If the answer to the query at Question Step 415 is no, the process proceeds to Question Step 423 through transition step 422. At Question Step 423, the process asks the user if it wishes to search for products by product description. If the answer to Question Step 423 is yes, the process proceeds to Process Step 425 through transition step 424.

At Process Step 425, the user inputs the product description it wishes to search the system and the system searches for the products most closely matching the product description input by the user. After Process Step 425, the process proceeds to Process Step 427 through transition step 426 where the products most closely matching the product description input by the user are displayed. After Process Step 427, the process proceeds to Question Step 412 through transition steps 428, 420 and 411.

If the answer to Question Step 423 is no, the process proceeds to Process Step 431 through transition step 430. At Process Step 431, the process displays thumbnail photos, photos or product descriptions for products available for purchase on the system. The system may organize the display of these offered products alphabetically, by offering party, by price, by product category, or in another manner specified by the user.

After Process Step 431, the process proceeds to Question Step 433 through transition step 432. At Question Step 433, the user may select the offered product displayed. If no selection is made after a predetermined time or after an appropriate inquiry in Question Step 433, the process proceeds to Question Step 412 through transition steps 434, 428, 420, and 411.

At Question Step 412, the process asks the user if it wishes to exit the subroutine. If the answer to Question Step 412 is no, the process proceeds to Question Step 403 through transition steps 404 and 402. If the answer to Question Step 412 is yes, the process proceeds to Exit Step 413 through transition step 414. At Exit Step 413, the process exits the subroutine shown in FIG. 7.

If a product is selected in Question Step 433, the process proceeds to Process Step 438 through transition step 437. At Process Step 438, the process displays the product information for the selected product. After Process Step 438, the process proceeds to Question Step 441 through transition step 440 where the system asks the user is it wishes to place a future price reservation on the selected product. If the answer to the Question Step 441 is yes, the process proceeds to Process Step 444 where the program registers the reservation of price as shown in the process steps of FIG. 5.

If the answer to Question Step 441 is no, the process proceeds to Question Step 450 through transition step 446 to allow the user to purchase the selected product immediately. If the immediate purchase is chosen by the user in Question Step 450, the process proceeds to “c” Continuation Step 453 through transition step 452.

If the answer Question Step 450 is no, the process proceeds to Question Step 458 through transition step 457. At Question Step 458, the process asks the user if it wishes to exit the subroutine in FIG. 7. If the answer to the query in Question Step 458 is yes, the process proceeds to Exit Step 462 through transition step 461 where the user exits the subroutine.

If the answer to Question Step 458 is no, the process proceeds to Question Step 403 through transition steps 460 and 402. While these process and question steps are shown in sequential or as consecutive steps, the process and question steps can be posed in a parallel fashion with each question and answer being subject to a parallel selection by the user on a webpage that others one or more selections simultaneously to the user for selection.

As shown in FIG. 8, the member registration process begins at Initiation Step 501, which proceeds to Process Step 505 through transition step 502. At Process Step 505, the process asks the user for its name and address information, as well as any other contact information related to that user. After Process Step 505, the process proceeds to Process Step 510 through transition step 506 where the user inputs the requested login code word and proposed password that will be maintained in a secure area of the system database and used to authenticate the user's identity in the future before allowing the user to have access to the system information.

After Process Step 510, the process proceeds to Process Step 514 through transition step 512 where the user inputs payment information such as credit card, debit card or bank account information into the system. Related information to the credit card or bank account can be input into the system at this step.

After Process Step 514, the process proceeds to Question Step 517 through transition step 515. At Question Step 517, the process asks the user to confirm the accuracy of the information input into the system. If the answer to Question Step 517 is no that the information is not confirmed as accurate, the process proceeds to Process Step 505, 510, or 514 through transition steps 518, 518a, 518b or 518c depending on what information is sought by the user to be corrected or modified.

If the input information is confirmed as accurate in Question Step 517, the process proceeds to Process Step 520 through transition step 519. At Process Step 520, the process updates the membership database information. After Process Step 520, the process proceeds to Exit Step 523 through transition step 522 where the user exits the subroutine shown in FIG. 8. While these process and question steps are shown in sequential or as consecutive steps, the process and question steps can be posed in a parallel fashion with each question and answer being subject to a parallel selection by the user on a webpage that others one or more selections simultaneously to the user for selection.

As shown in FIG. 9, the future reservation of product process begins at Initiation Step 601, which proceeds to Process Step 604 through transition step 602. At Process Step 604, the process displays the product information that the future reservation will pertain. This display will include useful product information, which can be adjusted by the user or the system programmer.

After Process Step 604, the process proceeds to Process Step 606 through transition step 605. At Process Step 606, the user (who is the prospective buyer) inputs information about the future reservation of a future price associated with the selected product. After Process Step 606, the process proceeds to Process Step 608 through transition step 607 where the future reservation is assigned a time stamp, which is saved in the system database.

After Process Step 608, the process proceeds to Process Step 612 through transition step 610. At Process Step 612, the process “tags” or designates the product with a future reservation based on the information and assignments input into the system by the user. The tag designation can be used by the system to review only the tagged or designated products for review and analysis by the system. Alternatively, all registered products can be analyzed and reviewed by the system. After Process Step 612, the process proceeds to Question Step 615 through transition step 614 where the system inquires whether the current terrace pricing for the selected product is equal to or less than the future reservation pricing input by the user.

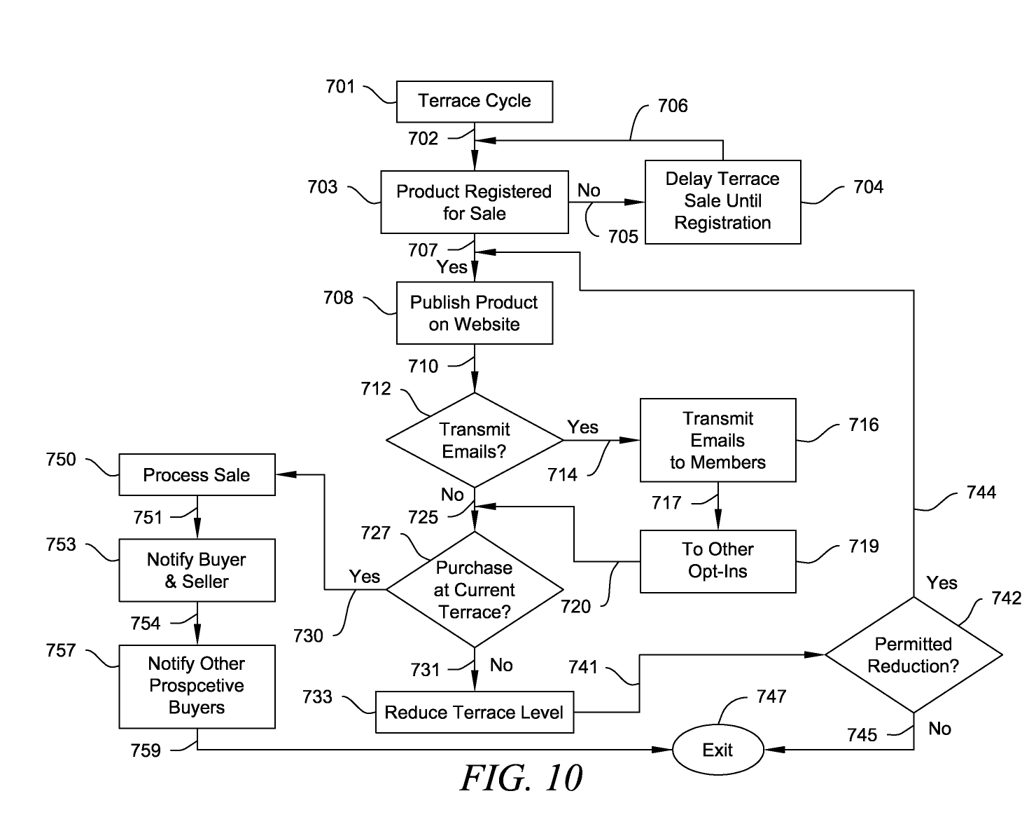

If the answer to the query at Question Step 615 is no, the process proceeds to Process Step 619 through transition step 616. At Process Step 619, the process system confirms whether there is any buyer for the selected product at its current terrace pricing. The terrace pricing subroutine in FIG. 10 is then implemented. After those process steps in FIG. 10 are completed and after Process Step 619, the process proceeds to Exit Step 640 through transition step 621 where the user exits the subroutine shown in FIG. 9.

During this time the potential buyers can track the number of days available and the progress of the product. Potential buyers can also place a “reservation’ or ‘buy order’ at one of the future Terraces. However, they cannot actually purchase the product until the product reaches that Terrace. If the product does reach that Terrace then the first reservation is the buyer. The user is notified if there is a current Terrace bid at the same level as his requested future reservation, and the user is given the option of increasing its future reservation pricing to set its priority over the existing future reservation.

Backups and priority reservations. If a previous potential buyer, say buyer (B), has already placed a reservation at the level the current potential buyer, buyer (A) wants to reserve at, then buyer (A) can either place a back up reservation or they can place a reservation at one of the other intervals.

If the answer to the query in Question Step 615 is yes, the process proceeds to Process Step 623 through transition step 618. At Process Step 623, the process confirms that the reservation pricing input by the user is equal to or more than the current terrace pricing assigned to the selected product. After Process Step 623, the process proceeds to Process Step 626 through transition step 625 where the sale of the selected product is processed.

Using the process steps shown above, for the sake of transparency, price drop intervals are published on a price reduction schedule. An example of a published table of price drops is shown below. If not purchased before a particular price drop occurs, the exact moment of each price drop and the expiratory date line will disappear so the current price cycle will move to the top. The example table published on the website shows a 10% price reduction every 14 days.

Published Price Decrement Table: Product Item “A”

| Start Date: | Start Time: | Start Price: |
|---|---|---|
| 1/10/12 | 1:00 pm cst | $10,000 |
| 1/24/2012 | 1:00 pm cst | $9,100.00 Buy |
| 2/7/2012 | 1:00 pm cst | $8,190.00 Reserve |
| 2/21/2012 | 1:00 pm cst | $7,371.00 Reserve |
| 3/6/2012 | 1:00 pm cst | $6,633.90 Reserve |
| 3/20/2012 | 1:00 pm cst | $5,970.51 Reserve |
| 4/3/2012 | 1:00 pm cst | $5,373.46 Reserve |

With the present on-line system, all items published for sale on the website will be sold on a first commitment basis. No one will be able to purchase an item at a price below the current asking price setting. A buyer will be able to make a future “reserve” commitment to buy an item after a specific price drop date and time occurs. When the reserve is set, the purchaser will be shown to have reserved the item at the moment the future price drop level. If someone does not purchase the item before that decrement in price, the person setting the reserve commitment will be shown to have bought or purchased the item.

If a person makes a future reserve commitment at one of the visible “price drop” levels, all of the published decrements below the reserved one can be removed from the “price drop” list or the word “Reserve” can be placed on those lower “price drop” levels. For example, if a person enters a “reserve” commitment on an item listed for a “price drop” at Mar. 6, 2012 at 1:00 pm cst for $6,633.90, that person will click on the reserve tab on that line and then register to purchase the work at that asking price. The buyer has to submit to the computer management system all their contact and credit card information, with a contractually binding commitment to purchase.

When finished and credit limit is confirmed on their credit card, all the times under that date will be removed from the table or listed as reserved. If no one purchases the item before the date and time of the reserved commitment decrement, the item will be purchased by the person who reserved it at that level. After the person has entered a reserve commitment onto the computer management system for the item at a specific price decrement level, another person can purchase the product item before the asking price is reduced to that specific price decrement level or place a reserve price commitment at a price above the highest reserved price decrement level.

In the above example, another person can place a reserve price commitment at Feb. 7, 2012 at 1:00 pm cst for $8,190.00, which is above the highest reserve pricing level for Mar. 6, 2012 of $6633.90. After this second person places a reserve commitment for the Feb. 7, 2012 price decrement, the present invention will inform the person who placed the reserve commitment at Mar. 6, 2012 at 1:00 pm cst for $6,633.90 that someone has committed to purchase the work at Feb. 7, 2012 at 1:00 pm cst for $8,190.00. The system will inquire if that person would like to purchase the work at the current price or place a higher reserve commitment price.

In this manner, purchasers can place advanced future reserve commitments significantly below a current asking price for a particular product item. When a potential buyer tries to place a reserve commitment at the same level, they are told that such an action is conflicted by a prior reserve commitment at that price level. The new buyer then has to decide whether to place a higher reserve commitment than previously entered in to the computer management system. The seller is also notified about reservations and sales of product.

After Process Step 626, the process proceeds to Process Step 630 through transition step 627 where the buyer and seller are notified of the sale. After Process Step 630, the process proceeds to Process Step 633 through transition step 631 where the other users who entered a future product reservation into the system are also notified about the sale of the selected product. After Process Step 633, the process proceeds to Exit Step 640 through transition step 635.

At Exit Step 640, the user exits the subroutine process steps shown in FIG. 9. While these process and question steps are shown in sequential or as consecutive steps, the process and question steps can be posed in a parallel fashion with each question and answer being subject to a parallel selection by the user on a webpage that others one or more selections simultaneously to the user for selection.

As shown in FIG. 10, the terrace cycle process begins at Initiation Step 701, which proceeds to Question Step 703 through transition step 702. At Question Step 703, the process asks the user if the product has been registered for sale, as opposed to simply input on the system as a registered product. The “for sale” designation can be used by the system to review only the tagged or designated products for review and analysis by the system. Alternatively, all registered products can be analyzed and reviewed by the system.

If the answer to the query at Question Step 703 is no, the process proceeds to Process Step 704 through transition step 705. At Process Step 704, the terrace sale processing is delayed for the registered product until it is put up for sale. After Process Step 704, the process proceeds back to Question Step 703 through transition steps 706 and 702.

After Question Step 703, the process proceeds to Process Step 708 through transition step 707. At Process Step 708, the process publishes the product designated “for sale” on the on-line terrace website where the product, description, pricing, authentication, and/or owner information are displayed depending on the desires of the system programmer and the owner of the product being sold.

After Process Step 708, the process proceeds to Question Step 712 through transition step 710. At Question Step 712, the process asks the user if it wishes for the new product designated for sale should be the subject of an email to registered members on the system notifying them about the registered product sale status and pricing. It the response to the query is yes in Question Step 712, the process proceeds to Process Step 716 through transition step 714 where the system sends out email messages notifying the members (or a selected subset of the membership) about the sale status and pricing on the registered product. After Process Step 716, the process proceeds to Process Step 719 through transition step 717 where other “opt-in” non-members are transmitted emails about the sale status on the registered product.

After Process Step 719, the process proceeds to Question Step 727 through transition steps 720 and 725. If the query is answered no at Question Step 712, the process proceeds to Question Step 727 through transition step 725. At Question Step 727, the process asks if there is a purchase of the registered “for sale” product at the current terrace pricing level.

If the answer to the query at Question Step 727 is no, the process proceeds to Process Step 733 through transition step 731. At Process Step 733, the process determines that the next lower terrace pricing level should be assigned to the product registered for sale. That next lower terrace pricing level is assigned to the product in Step 733, and the amount of the decrement on the pricing is a uniform decrement or defined by the user in a separate subroutine during product registration.

After Process Step 733, the process proceeds to Question Step 742 through transition step 741 where the system confirms whether the terrace reduction is permitted by the user defined sales parameters. If the answer to the query in Question Step 742 is yes, the process proceeds to Process Step 708 through transition steps 744 and 707 where the new terrace pricing on the offered product is published on the website, and subsequently, marketed through electronic communications to members and others. If the answer to the query in Question Step 742 is no, the process proceeds to Exit Step 747 through transition step 745.

After Question Step 727, the process proceeds to Process Step 750 through transition step 730. At Step 750, the system processes the sale of the selected product purchased at the current terrace sales level. After Process Step 750, the process proceeds to Process Step 753 through transition step 751 where the buyer and seller are notified of the sale. After Process Step 753, the process proceeds to Process Step 757 through transition step 754 where the other users who entered a future product reservation into the system are also notified about the sale of the selected product. After Process Step 757, the process proceeds to Exit Step 747 through transition step 759.

At Exit Step 747, the user exits the subroutine process steps shown in FIG. 10. While these process and question steps are shown in sequential or as consecutive steps, the process and question steps can be posed in a parallel fashion with each question and answer being subject to a parallel selection by the user on a webpage that others one or more selections simultaneously to the user for selection.

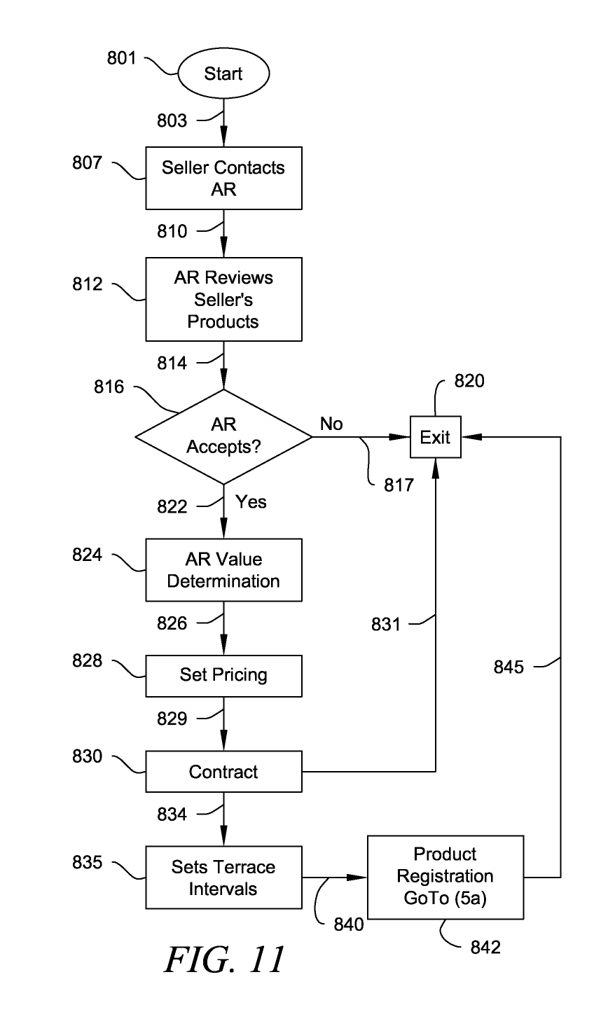

As shown in FIG. 11, the authorized representative engagement process begins at Initiation Step 801, which proceeds to Process Step 807 through transition step 803. At Process Step 807, the seller contacts an authorized representative about providing assistance to the seller in the sale of a product or item. After Processing Step 807, the process proceeds to Processing Step 812 through transition step 810. In Step 812, the authorized representative reviews the seller's product.

After Processing Step 812, the process proceeds to Question Step 816 through transition step 814 where the process asks if the Authorized Representative will accept the assignment and engagement of representation of the seller. If the answer to the query in Question Step 816 is no, the process proceeds to Exit Step 820 through transition step 817.

If the answer to the query in Question Step 816 is yes that the Authorized Representative will accept the assignment and engagement of the seller, the process proceeds to Process Step 824 through transition step 822. In Process Step 824, the Authorized Representative determines the valuation of the product or item to be sold, and the process proceeds to Process Step 828 through transition step 826 where the pricing is set for the product or item to be sold.

After the pricing is set, the process proceeds from Process Step 828 to Process Step 830 through transition step 829. In Process Step 830, the process allows the seller or user to engage the authorized representative with an on-line contract. If the contract terms are not agreed upon in Process Step 830, the process proceeds to Exit Step 820 via transition step 831.

If the contract terms are agreed upon in Process Step 830, the process proceeds to Process Step 835 where the product or item terraces levels are input into the system. After Process Step 835 is completed, the process proceeds to Process Step 842 through transition step 840 where the product registration steps shown in FIG. 5 are performed by the Authorized Representative as the agent for the seller. After completion of those steps and Process Step 842, the process proceeds to Exit Step 820 through transition step 845.

As shown in FIG. 11, the engagement of authorized representative's process begins at Initiation Step 901, which proceeds to Question Step 906 through transition step 905. At Process Step 906, the process accepts nominations or identification of possible representatives. After Process Step 906, the process proceeds to Process Step 908 through transition step 907. At Process Step 908, the process provides information for the possible representatives to users for review and analysis of their qualifications. Information made available to the user at this step includes the possible representative application, public information regarding the candidate representative, reputation and reference information, evidence of financial stability, and listings of physical resources of candidate representative.

After Process Step 908, the process proceeds to Process Step 910 through transition step 909. At Process Step 910, the process allows the possible representatives to meet telephonically or via video conference with the system administrators and/or users. After Process Step 910, the process proceeds to Process Step 913 via transition step 912 where the possible representative may be offered a contract to become an Authorized Representative, which can be an on-line contract. After Process Step 913, the process proceeds to Exit Step 917.

The on-line system may derive revenue from various sources, such as membership and registration fees, auction transaction fees (based on listed asking price when registered), commission fees, and premium purchase fees (high priced items sold above a specified amount of money). Moreover, the webpage can generate revenue from on-line advertising and escrow commissions.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

This disclosure is illustrative but not limiting; further modifications and embodiments will be apparent to those of skill in the art in light of this disclosure, and are intended to fall within the scope of the appended claims.

1. A method for conducting an on-line sale of an item, comprising the steps of:
providing a computer-based management system having one or more input/output ports, a central processing unit, an internal memory and an associated memory database,
coupling the computer management system to a communication network,
registering an item for sale on the computer management system through an intermediary using the communication network,
publishing the item for sale on an interactive website maintained and updated by the computer management system,
identifying an initial asking price for said item on the interactive website offering the product for sale based on input from intermediary;
preparing a price drop table based on input from intermediary, said price drop table showing one or more price reductions from the initial asking price for the item offered for sale, a time and a date for each price reduction identified on the price drop table;
publishing the price drop table on the interactive website;
processing the sale of the offered item if a person accepts the current asking price with sufficient purchasing commitments and purchasing information;
placing a future reserve commitment on the item offered for sale at a price drop level to be initiated in the future, after a person accepts the future asking price drop level shown on the price drops table with sufficient purchasing commitments and purchasing information;
designating the future reserve commitment on the price drop table, and
processing the sale of the offered item if the price is reduced through a price drop to a matching future reserve commitment price level.

2. The method according to claim 1, wherein the price of the item offered for sale is reduced from a designated initial asking price to a price drop level at regular periodic predetermined time periods.

3. The method according to claim 1, wherein the price of the item offered for sale is reduced from a designated initial asking price to a price drop level at variable designated periods of time.

4. The method according to claim 1, wherein the price of the item offered for sale is reduced from an initial asking price to a price drop level at predetermined stepwise reduction levels.

5. The method according to claim 1, wherein the price of the item offered for sale is reduced from an initial asking price to a price drop level at predetermined stepwise variable reduction levels.

6. The method according to claim 1 wherein notifications are transmitted to persons registering a lower future reserve commitment when a higher future reserve commitment is entered onto the computer management system.

7. The method according to claim 1 wherein the item owner is notified when the item is purchased.

8. The method of claim 1 wherein sales is cancelled after the expiration of a first period of time.

9. The method of claim 1 wherein sale terminates after last price drop is maintained over a first predetermined time period.

10. A system that conducts an on-line sale of an item, comprising:
a computer-based management sub-system having one or more input/output ports, a central processing unit, an internal memory and an associated memory database, and said management sub-system being coupling the computer management system to a communication network and said computer management sub-system receiving a registration of an item to be offered for sale on the system through an intermediary using the communication network,
an interactive website published by the system and maintained and updated by the computer management system, an initial asking price for said item on the interactive website offering the product for sale based on input from intermediary;
a price drop table prepared by computer-based management sub-system based on input from intermediary, said price drop table showing one or more price reductions from the initial asking price for the item offered for sale, a time and a date for each price reduction identified on the price drop table;
a future reserve commitment on the item offered for sale being placed at a price drop level to be initiated in the future, after a person accepts the future asking price drop level shown on the price drops table with sufficient purchasing commitments and purchasing information, said future reserve commitment being designated on the price drop table, and
said computer-based management sub-system processing the sale of the offered item if a person accepts the current asking price with sufficient purchasing commitments and purchasing information or processing the sale of the offered item being processed if the price is reduced through a price drop to a matching future reserve commitment price level.

11. The system according to claim 10, wherein the price of the item offered for sale is reduced from a designated initial asking price to a price drop level at regular periodic predetermined time periods.

12. The system according to claim 10, wherein the price of the item offered for sale is reduced from a designated initial asking price to a price drop level at variable designated periods of time.

13. The system according to claim 10, wherein the price of the item offered for sale is reduced from an initial asking price to a price drop level at predetermined stepwise reduction levels.

14. The system according to claim 10, wherein the price of the item offered for sale is reduced from an initial asking price to a price drop level at predetermined stepwise variable reduction levels.

15. The system according to claim 10 wherein notifications are transmitted to persons registering a lower future reserve commitment when a higher future reserve commitment is entered onto the computer management system.

16. The system according to claim 10 wherein the item owner is notified when the item is purchased.

17. The system of claim 10 wherein sales is cancelled after the expiration of a first period of time.

18. The system of claim 10 wherein sale terminates after last price drop is maintained over a first predetermined time period.

19. A method for conducting an on-line sale of an item, comprising the steps of:
providing a computer-based management system having one or more input/output ports, a central processing unit, an internal memory and an associated memory database,
registering an item for sale on the computer management system;
publishing the item for sale to notify the public about the item;
identifying the initial asking price for said item on the interactive website offering the product for sale based on input from user;
preparing a price drop table based on input from intermediary, said price drop table showing one or more price reductions from the initial asking price for the item offered for sale, a time and a date for each price reduction identified on the price drop table;
publishing the price drop table to notify the public about the schedule of price drops;
processing the sale of the offered item if a person accepts the current asking price with sufficient purchasing commitments and purchasing information;
placing a future reserve commitment on the item offered for sale at a price drop level to be initiated in the future, after a person accepts the future asking price drop level shown on the price drops table with sufficient purchasing commitments and purchasing information;
designating the future reserve commitment on the price drop table, and
processing the sale of the offered item if the price is reduced through a price drop to a matching future reserve commitment price level.

20. The method according to claim 19, wherein the price of the item offered for sale is reduced from a designated initial asking price to a price drop level at regular periodic predetermined time periods.

21. The method according to claim 19, wherein the price of the item offered for sale is reduced from a designated initial asking price to a price drop level at variable designated periods of time.

22. The method according to claim 19, wherein the price of the item offered for sale is reduced from an initial asking price to a price drop level at predetermined stepwise reduction levels.

23. The method according to claim 19, wherein the price of the item offered for sale is reduced from an initial asking price to a price drop level at predetermined stepwise variable reduction levels.

24. The method according to claim 19 wherein notifications are transmitted to persons registering a lower future reserve commitment when a higher future reserve commitment is entered onto the computer management system.

25. The method according to claim 19 wherein the item owner is notified when the item is purchased.

26. The method of claim 19 wherein sales is cancelled after the expiration of a first period of time.

27. The method of claim 19 wherein sale terminates after last price drop is maintained over a first predetermined time period.
